(19) United States
(12) Patent Application Publication
(10) Pub. No.: US 2016/0063532 A1
(43) Pub. Date: Mar. 3, 2016

(54) SYSTEM AND METHOD OF ELECTRONICALLY INCENTIVIZING HEALTHY FOOD PURCHASING

(71) Applicant: MOBISAVE LLC, New York, NY (US)

(72) Inventors: Michael R. Loeb, New York, NY (US); Steven Marcus, New Rochelle, NY (US); Richard I. Vogel, New Canaan, CT (US); Edward J. McCabe, New York, NY (US)

(21) Appl. No.: 14/939,306

(22) Filed: Nov. 12, 2015

Related U.S. Application Data
(63) Continuation-in-part of application No. 12/950,103, filed on Nov. 19, 2010.
(60) Provisional application No. 61/263,211, filed on Nov. 20, 2009.
(60) Provisional application No. 61/264,549, filed on Nov. 25, 2009.
(60) Provisional application No. 61/292,940, filed on Jan. 7, 2010.
(60) Provisional application No. 61/380,453, filed on Sep. 7, 2010.

(51) Int. Cl. G06Q 30/02; G06F 17/27; H04L 29/06

(52) U.S. Cl. CPC G06Q 30/0224; H04L 63/1425; G06F 17/2705

(57) ABSTRACT

In a health promotion system, a receipt relating to a purchase of food is received. The contents of the receipt are compared with wellness incentive and/or disincentive data. A user's incentive account is updated based on a result of the comparison of the receipt with the incentive/disincentive data.

### CROSS-REFERENCE TO RELATED APPLICATIONS

This application is a continuation-in-part of U.S. patent application Ser. No. 12/950,103, filed Nov. 19, 2010 entitled “SYSTEM AND METHOD OF ELECTRONICALLY VERIFYING REQUIRED PROOF-OF-PERFORMANCE TO SECURE PROMOTIONAL REWARDS” (now pending), which claimed benefits to the following provisional applications: U.S. Patent Application No. 61/263,211, filed on Nov. 20, 2009, (expired); U.S. Patent Application No. 61/264,549, filed Nov. 25, 2009 (expired); U.S. Patent Application No. 61/292,940, filed Jan. 7, 2010 (expired); and U.S. Patent Application No. 61/380,453, filed Sep. 7, 2010 (expired). The entire contents of those applications are incorporated herein by reference in their entirety for all purposes.

### BACKGROUND

### Field

This invention relates to electronically facilitating promotion of healthy dietary, hygiene and lifestyle habits.

Many health problems are believed to be the result of poor diet. In some societies, a large proportion of the population is overweight, or even obese, with resulting adverse effects on the individuals' health. Attempting to eat a healthy diet is not only a matter of shopping and eating habits but also has an economic dimension, as it may be more expensive to subsist on foods that are better for one's health. At the same time, the health problems caused by poor diet are believed to significantly increase the total expenditures for health care. The burden of diet-related poor health is believed to fall more heavily on those who have lower incomes.

Poor hygiene such as dental hygiene can also result in higher total expenditures for health care. Similarly, exposure to sun without using sunscreen can cause cancer.

### SUMMARY

In an aspect of the invention, a proof-of-performance verification system may include a receipt processing facility that receives a receipt image, wherein the receipt processing facility optionally enhances the receipt, converts the receipt image to text, and matches the text to a product or service description in accordance with a terminology database, a proof processor that electronically matches a user-selected reward offer against the product or service description to facilitate offer redemption, and at least one of a payment facility that distributes the offer redemption funds and a rewards facility that communicates incentive rewards to a central location. The receipt image may be captured by an imaging facility of a handheld device, wherein the handheld device may be a mobile phone camera or web-enabled digital camera.

The receipt image may be captured by at least one of a webcam, flatbed scanner, a machine designed to capture and transmit images, and an in-store device that allows users to scan and transmit a receipt image. The proof processor may capture and store all information contained on the receipt image. The system may further include a graphical user interface that may allow a user to enter their identification information and/or select at least one offer. The system may further include a rewards offer facility that presents offers that can be redeemed with one or more receipt images as proof-of-performance. The system may further include a reporting facility that provides real-time tracking of offers and redemptions. The system may further include a dashboard that allows offer sponsors to manage and track offers and redemptions.

In an aspect of the invention, a method may include presenting at least one offer to a user for offer selection prior to a purchase of a corresponding product, wherein at least one selected offer can be redeemed by the user with a proof of purchase receipt for the corresponding product, receiving a proof of purchase receipt from a user, wherein the receipt is at least one of a receipt image and a digital receipt, in the case where the receipt is a receipt image, processing the receipt image by converting the receipt image to text using optical character recognition, matching at least one of the text of the receipt and a product code indicated by the receipt with a product or service description in a terminology database to determine at least one product indicated by the receipt, and matching the at least one product to the at least one selected offer, wherein a successful match of a selected offer to a purchased product as indicated by the proof of purchase receipt results in a redemption of the selected offer.

The method may further include enhancing the receipt by at least one of removing creases and modifying contrast. The product code may be one or more of a UPC code, text, or an SKU. Upon a successful product and offer match, a notification may be sent to the user. Upon a successful product and offer match, the redemption fund may be automatically transferred to the user.

In an embodiment, a computer program product may be embodied in a computer readable medium that, when executing on one or more computers, performs the steps of displaying, via a graphical user interface, an inventory list of product offers redeemable by users upon presentation of a proof of purchase receipt, receiving an input, via the graphical user interface, from a user, the input specifying a desired product offer from the inventory list of product offers to be redeemed after purchase of a corresponding product, receiving an input, via the graphical user interface, from a user, the input comprising the proof of purchase receipt from the user, wherein the receipt is at least one of a receipt image and a digital receipt, displaying, via the graphical user interface, an indication of a successful match of the desired product offer with a proof of purchase of a corresponding product, and displaying, via the graphical user interface, an indication of a redemption of the product offer, wherein the indication comprises an indication of a payment.

In an aspect of the invention, a method of aggregating consumers for a group purchase may include negotiating a cash back offer from a manufacturer, wherein the offer is contingent on a threshold number of users accepting the offer to purchase the product offered by the manufacturer, wherein the manufacturer's product is purchased from any retailer, providing each user an offer to participate in a group discount, wherein each member of the group purchases the opportunity to receive the offer upon verifying that a purchase of the manufacturer's product has been made, receiving proof of purchase verification from the user in the form of a digital image of a receipt or a digital receipt and, optionally, an indication of a registration card, and transmitting payment to the user who purchased the opportunity to receive the offer and subsequently verified that they purchased the product. Verification may include processing a digital image of the receipt for the manufacturer's product to extract proof-of-performance information, and electronically matching the discount offer against the proof-of-performance information.

In an aspect of the invention, a secure digital receipt system may include a receipts server in communication with a point-of-sale that prepares a secure digital receipt comprising an unalterable digital mark, associating the secure digital receipt with a user identification, and a communications facility that delivers the secure digital receipt to a user. The unalterable digital mark may prevent at least one of alteration, counterfeiting or duplication of the secure digital receipt. The unalterable digital mark is at least one of a bar code, QR code, or image. The unalterable digital mark may encode information including user ID, encryption device or image, encoded text, and a date. The user identification may include at least one of a unique sender ID, an email address and a mobile phone number. Another form of ID including at least one of a fingerprint, eye scan, facial recognition and password may be required to verify the identity of the user possessing the secure digital receipt.

In an aspect of the invention, a voice recognition system may include a voice recognition facility that recognizes a spoken word as a shopping list item, a user interface of the voice recognition facility that enables a user to create and edit a shopping list, wherein the shopping list is generated using the recognized shopping list items and, optionally, manually input shopping list items, and a rewards offer facility that comprises coupons, rebates, or other incentives related to the shopping list items, wherein when the shopping list item is recognized, the shopping list item is searched in a database of coupons or rebates or other purchase incentives for a match to communicate to a user. The voice recognition system may reside on an electronic device. The voice recognition system may reside on a server. The voice recognition system may further include a communications facility that transmits the shopping list to a shopping service that will pick and pack the shopping list items.

In an aspect of the invention, a voice recognition system may include a voice recognition facility that recognizes a spoken word as a shopping list item, a user interface of the voice recognition facility that enables a user to create and edit a shopping list, wherein the shopping list is generated using the recognized shopping list items and, optionally, manually input shopping list items, and a rewards offer facility that stores coupons, rebates, or other incentives related to the shopping list items, wherein when the shopping list item is recognized, the shopping list item is searched in a database of advertisements for a match to communicate to a user. The voice recognition system resides on an electronic device or a server. The voice recognition system may further include a communications facility that transmits the shopping list to a shopping service that will pick and pack the shopping list items.

In an aspect of the invention, a method may include receiving a receipt from a food purchase, comparing contents of the receipt with wellness incentive and/or disincentive data, and updating a user's incentive account based on a result of the comparing step.

In an aspect of the invention, a wellness-incentive system may include a computer storing a database, which contains incentive and/or disincentive data. The wellness-incentive system may further include a receipt processing module configured to process food purchase receipts. The wellness-incentive system may further include a determination module that is operatively coupled to the computer and to the receipt processing module. The determination module may be configured to (a) compare contents of food purchase receipts with incentive and/or disincentive data contained in the database, and (b) determine consumer incentive and/or disincentive results based on the receipt contents and the incentive and/or disincentive data.

In an aspect of the invention, a method includes receiving an image of a purchase transaction receipt, translating the image into purchase transaction text data, determining food purchases by a user from the text data, comparing the food purchases with food purchase rules that apply to the user, updating the user's incentive account based on the rules and the food purchases, and disbursing a benefit to the user from the incentive account.

In an aspect of the invention, a method includes receiving—in a computer—a request for offers from a user, and determining that the computer stores food offers authorized specifically and individually for the user. The food offers may be sponsored by a wellness promotion organization. The method may further include presenting the determined food offers to the user, receiving—at at least one selection time—indications that the user has selected ones of the presented food offers, and storing the at least one selection time in the computer. The method may also include receiving—by the computer—a proof of purchase receipt from the user. The receipt may represent a date and time of a purchase transaction that included food items; the receipt may list the food items. Still further, the method may include matching at least one of the listed food items to a respective at least one of the selected food offers, confirming that the date and time of the purchase transaction is later than a corresponding selection time of the matched at least one selected offer, and—based on results of the matching and confirming steps—providing a benefit to the user.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 depicts a block diagram of a proof-of-performance verification system.

FIG. 2 depicts a secure digital receipt system.

FIG. 3 depicts a voice recognition system.

FIG. 4 depicts a series of images depicting a method of using the proof-of-performance verification system.

FIGS. 5A, 5B and 5C depict a logical flow for a method of using the proof-of-performance verification system.

FIG. 6 depicts a screenshot of a manufacturer dashboard.

FIG. 7 depicts a wellness-incentive system.

FIG. 8 depicts a computer that may be part of the wellness-incentive system.

FIG. 9 depicts a mobile device that may be used in connection with the wellness-incentive system.

FIGS. 10, 11 and 12 depict logical flows for a method of using the wellness-incentive system.

FIG. 13 depicts an offer-based wellness-incentive system.

FIG. 14 depicts a logical flow for a method of using the offer-based wellness-incentive system.

FIG. 15 depicts constituent components of the wellness-incentive system.

### DETAILED DESCRIPTION

The invention allows consumers to secure promotional rewards, such as rebates for purchases or any other desired action, by electronically submitting proof-of-performance, such as proof-of-purchase or proof-of-visit, to the reward sponsor or reward processor in a proof-of-performance verification system. Such actions may occur either in physical retail outlets, at an in-store kiosk or scanning system, on the Internet, by using a webcam attached to a computer, on a communication device 108 such as a mobile phone or web-enabled digital camera, via postal mail or in any manner as desired and acceptable to the reward sponsor. Such proof may be in any electronic form including but not limited to scanned or photocopied receipts, video copied rewards, paperless receipts in the form of emails or text messages, downloaded receipts or performance data from a database of transactions, scanned itemized receipts collected by shoppers on a handheld device or other device, or direct transmission from any source that can provide and prove actual performance behavior.

In a wellness-incentive system, receipts for purchases of food may be submitted by participants in the system. The receipts may be parsed and food items purchased may be automatically compared with data that indicates what the participants are or are not to be incentivized to purchase. Based on the data and the contents of the purchase receipts, incentives and/or disincentives may be applied to the participants' incentive accounts. Submission of food purchase receipts may be streamlined in similar fashion to techniques employed in the proof-of performance verification system, including in some cases capturing images of paper receipts via a mobile phone camera.

In a hybrid of the wellness-incentive system and the proof-of performance verification system, incentives may be made available to participants as offers on an individualized basis. The participants/consumers may select individualized offers prior to food shopping, and proof-of-performance verification and provision of rewards to the participants may follow processes employed in the proof-of-performance verification system.

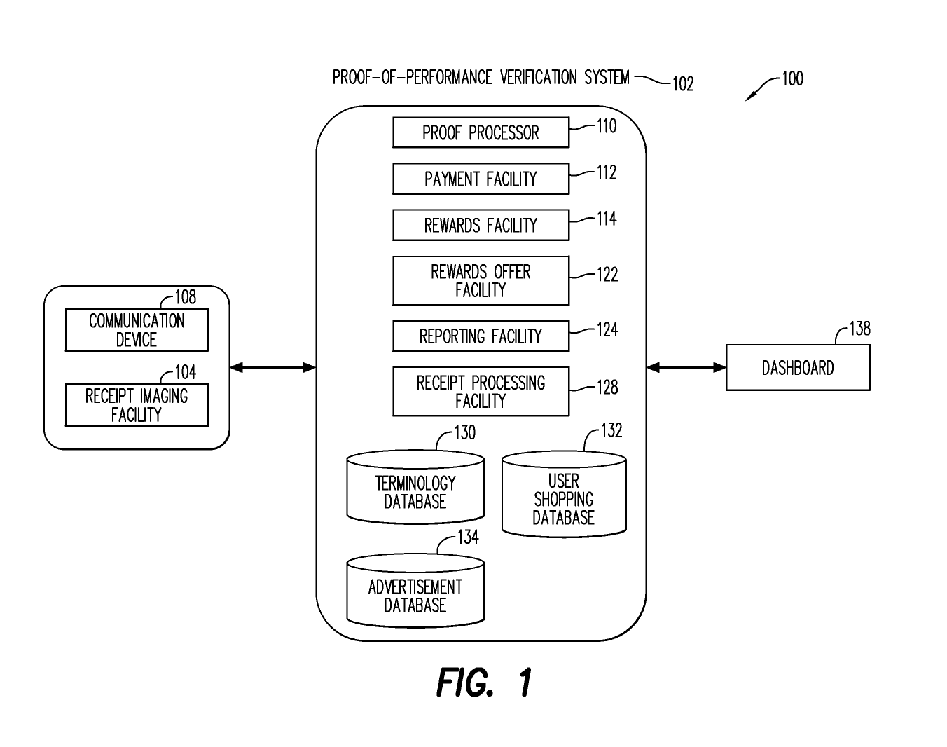

The communication device 108 (FIG. 1) may include a physical user interface that allows a user to enter their identification information and display offers and rebates. The user may provide personal identification via keyboard, touch screen, dipping a card, voice recognition, or any other method such as having a sent image tagged with their email address or mobile phone number.

In an embodiment, the system may enable retailer-agnostic rebates and offers—the offer or rebate may be made by the manufacturer of the item and the system may enable redemption of the offer or rebate regardless of where the item may be purchased. Thus, the user is free to purchase the item from any retailer, website, home shopping network, or the like, enabling them to get the best retail price, while still being eligible for additional savings with the manufacturer's rebate/offer that may be redeemed using the system of the invention. The system may include a rewards offer facility 122 that offers many rebates that can be submitted and approved with one or more receipts as proof-of-performance rather than individual proof-of-performance for each offer.

In certain embodiments, a registration card may also be required by the system in order for users to redeem receipts, such as by providing personal identification information. The registration card may enable third parties associated with the system, such as manufacturers, distributors and the like, to acquire customers using the information provided with the registration card.

In an embodiment, a user may learn about promotional offers through any medium including newspaper ads, email/SMS/MMS to their personal computer or their mobile phone, in-store through any advertising device, through a social networking website, through the proof-of-performance verification system, on a home shopping network television station, and the like.

In an embodiment, the user may interact with an application embodying the proof-of-performance verification system to review, select, and redeem offers. The system may be available for such interaction on a smartphone, mobile phone, web-enabled device, desktop computer, laptop computer, tablet computer, kiosk, web-enabled camera, and the like. Offers may be searched by category, product, offer amount, offer details, and the like. In an embodiment, the user may pre-select the offers they want to receive or redeem prior to purchasing the qualifying product. The user may print a list of the offers or download or send such offers to their mobile devices such as smart phones or other web enabled devices. In an embodiment, the system may present offers to individual members based on prior behavior or other distinguishing factor.

The user may then shop, either in a store or via an online shopping website, using the printed list or electronically viewing the selected offers, check out or otherwise pay for items, and retain the paper receipt and/or obtain an electronic receipt. In an embodiment, pre-selection of offers may be required in order to obtain an incentive for actually following through and making the purchase. In some embodiments, offers may be redeemed for items where the offer was not pre-selected but identified as a match anyway by the proof processor 110. Once the purchases have been completed, the user then is able to redeem the offers they pre-selected. The paper or digital receipt serves as the proof-of-performance for offer redemption. The system 102 accepts the receipts for processing in order to determine if an item for which an offer was pre-selected was indeed purchased. Multiple offers may be redeemed using a single receipt.

The proof-of-performance verification system 102 may include inputs from a receipt imaging facility 104, wherein the imaging facility 104 includes facilities for image and/or video capture, and optionally, enhancement and conversion of receipts to proof-of-performance. The imaging facility 104 may be connected to or integral with a communication device 108 that connects to a network, wherein the communication device 108 enables communication between the user and the system 102. The imaging facility 104 may be a handheld device, such as a mobile phone camera or web-enabled digital camera. The imaging facility 104 may be at least one of a webcam, flatbed scanner or a machine designed to capture and transmit images. The imaging facility 104 may be an in-store device that allows users to scan and transmit proof-of-purchase. The communication device 108 may be a kiosk, cell phone, smart phone, PDA, computer, tablet computer, and the like.

For example, the user may use a handheld device, such as a communication device 108, to photocopy or scan the receipt or they may visit a location in-store/nearby/in their office or home where a machine resides that can capture the required receipt image or electronic data. In one embodiment, the scan of the receipt may be in the form of series of photos which may be electronically joined together or a video of the receipt. In an embodiment, the imaging facility 104 may include automated features that facilitate capturing an image of the receipt. For example, in order to capture a series of photos to join into a single image of a long receipt, an accelerometer embedded in the communication device 108 may indicate that the user is holding the device 108 level and assist in steadying the image. When a first image is taken, the length of the portion of the receipt is determined. When the user goes to take the second image of the next portion of the long receipt, as the camera is moved down the receipt into position, the camera automatically senses where the last image left off by the length along the receipt travelled by the communication device 108, which may be sensed by an embedded accelerometer or other sensor that makes measurements such as length. In an embodiment, the device may indicate that the user should stop moving the camera. In other embodiments, the camera may automatically snap an image when it reaches an unimaged portion of the receipt. In an embodiment, a graphical user interface 102 may include a level bubble to graphically indicate when level has been reached.

In an embodiment, the proof processor 110 may capture and store all information contained on the proof-of-performance, including user information.

The receipts transmitted to the proof-of-performance verification system 102 may be sent to a proof processor 110 that electronically matches a reward offer against a proof-of-performance redemption. The proof processor 110 may include image enhancing software and/or image conversion software that converts images into PDF, searchable text or images that can be recognized by humans or machines. The users scanned receipt may be enhanced and interpreted such as with the electronic receipt processing facility 128, which may include technology to remove creases, modify contrast, and the like and OCR technology to convert the scanned receipt to searchable text. Image enhancement and/or processing may be done on the user's handheld device or at an Internet location, such as a server, where the user may submit receipts. The scanned image may be automatically routed to another location for processing. Through two-way communication, the user may be advised that the image may have been successfully received for processing. In the event the user may not provide an adequate scan for processing, alternate methods of submission may be available ranging from flatbed scanners to actually mailing in the receipt.

In an embodiment, the receipt may be identified as belonging to a specific user via the telephone number from which it was submitted, the email address or home address from which it was submitted or emailed, identifying information on the receipt such as one or more of a loyalty card number, credit card number, user name, and the like.

The proof processor 110 may be able to match the text of the receipt with the known shorthand, codes, names, UPC codes, and the like for items from the terminology database 130 via an integrated matching engine. The matching engine may employ a similarity algorithm to decode product or service descriptions on receipts, using information stored in the terminology database 130, and convert them into useful data. For example, a receipt may include a number of grocery items that may be referred to using shorthand or other terminology, names or codes that may be specific to a particular grocery store. The terminology may be supplied to the terminology database 130 by the grocery store, purchased from a third party, or generated by the system 102 provider. In an embodiment, the contents of the entire receipt may be matched by the proof processor 110 or only a subset of items may be matched. For example, the receipt may have categories of products, such as certain grocery store receipts that are categorized along the lines of produce, health and beauty aids, butcher shop, and the like. In this example, the proof processor 110 may only process categories of items that align with the categories of offers selected by the user. In an embodiment, the system may take the OCR output on the entire receipt line-by-line to look for the best matches for the product or service descriptions. The terminology database may have a plurality of variations of the product or service descriptions corresponding to the various terminology used by various retailers. In an example, a similarity score threshold may be set, such as on a scale of 1 to 1000 where 1000 is a perfect match, and if one or more lines is at or above that threshold, a positive match may be declared. If more than one line is above the threshold, the system may take the highest score as the best match positive match and declare that the winner.

In an embodiment, the system 102 may include normalization technology to normalize various codes and shorthand used by different vendors for a single item. Continuing with the example of a receipt from a grocery store, bananas may be referred to as BANS by one store, and BNAS in another store, and BNNAS by a third store. The terminology database 130 may be able to normalize the various terminologies by indicating that all three terminologies refer to the same product.

In an embodiment, a predictive algorithm may be used by the system to detect unknown descriptions, build a list of terminologies used by a vendor for which the system 102 does not have database entries, and the like. Continuing with the example of grocery, a store may not choose to provide their terminologies to the terminology database 130. One way of beginning to build a terminology database 130 for the grocery store is through iterative learning from receipts.

In an embodiment, the terminologies in the terminology database 130 may be modified or corrected after receiving feedback, such as an indication from a plurality of users that a supermarket may have changed their terminology for a particular item.

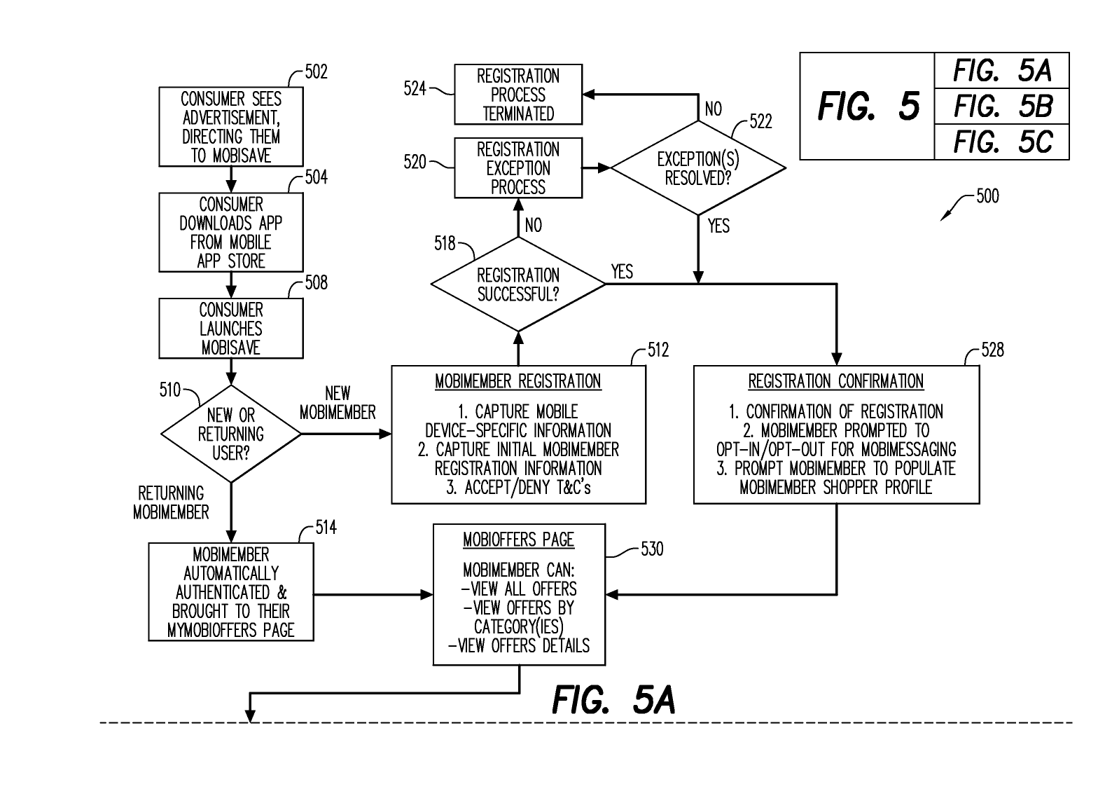

At this point, and referring to FIG. 4, a user may have interacted with the system 102 to browse and select offers that they would like to receive next time they shop. They then can go shopping and either receive a digital receipt for submission to the system or a paper receipt for imaging and image processing. In any event, the proof processor 110 may decode what products appear on the receipt using an algorithm and a terminology database 130. The proof processor 110 may then match the pre-selected offers to the products actually purchased by the user or search the products on the receipt by all known product or service descriptions for the selected offer or offers. In embodiments, a successful match may be indicated by surpassing a threshold score for similarity. For example, a positive match may be declared when one or more receipt lines score above the threshold.

When a successful match is made, an indication may be sent to a payment facility 112 that distributes the reward or rebate. In an embodiment, the user may be shown the results of the processing at the scanner location, on their handheld device or other location advising them of the promotional rewards that have been processed and approved. The reward may be a cash rebate, a mailed check, a direct deposit, rewards points, frequent flier miles, a gift card, and the like. The rewards may be credited to a holding account, sent to the user in the form of a negotiable instrument, credited to an account for later use or retrieval, sent to a bank account, optionally transmitting the payment by ACH, to a credit or debit card, to an online payment system such as PAYPAL, to a holding account that can be used for online purchases optionally with a bonus, to a stored-value card, and the like. A rewards facility 114 may communicate incentive rewards to a central location. The payment facility 112 may obtain money from an escrow account funded by a manufacturer, write to a stored-value card or perform some other financial transaction. In an embodiment, the manufacturer may pay for the redemption by directly transferring money to a user account. The user may check the status of the reward processing on their mobile phone or at any other location connected to the Internet.

In cases where there was no pre-selection of an offer, a reduced offer may be presented or a cumulative offer may be initiated. For example, the receipt scan and interpretation may show that the user purchased a bag of grapes. While there may be no current offer for grapes or the user may not have pre-selected an offer for grapes, the user may be enabled to initiate a cumulative purchase offer for future purchases of grapes. In an embodiment, the offer may be time sensitive.

When the user is informed of what they have saved, the system may then show the list of offers that were matched where the user is given the opportunity to indicate if a match was missed. If they indicate that a match was missed, the system may provide a facility for identifying the missing items, such as by highlighting the OCR'd receipt, sending an email, sending an MMS/SMS, providing feedback on a website or mobile application presenting the system, and the like. The system may then be prompted to one or more of correct the OCR, update the terminology database and credit the user for the found item.

In certain embodiments, at checkout a user may present a unique identifier recognized by the system 102, such as in the form of a card, bar code or QR code on a mobile device, RFID-embedded tag in a mobile device, NFS card, retinal scan, fingerprint, facial recognition scan, or the like. The unique identifier may be used to tag the retailer's transaction log for that user's market basket. Either on a real-time basis or any other time after purchase, the tagged transactions are used to match purchases against offers selected. Payment to users may be made as described herein.

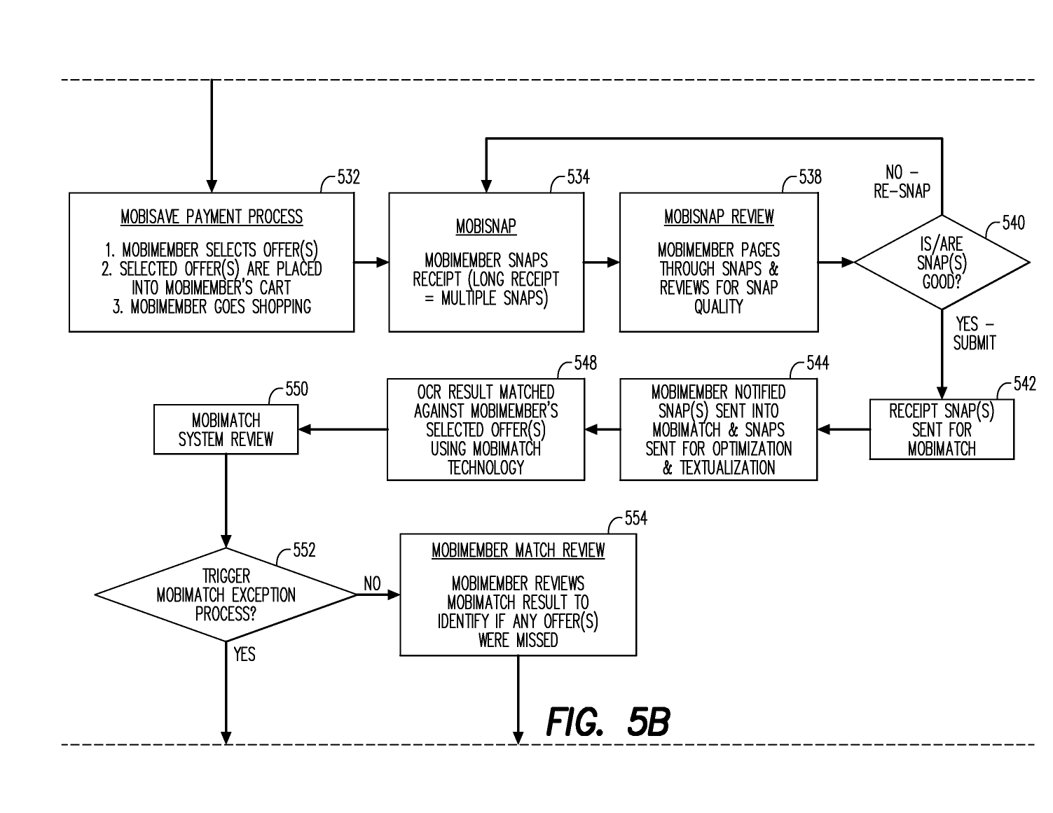

Referring to FIGS. 5A, 5B and 5C, a flowchart for an embodiment of the proof-of-performance verification system is depicted. At step 502, a user may see an advertisement directing them to a website or other portal for accessing the system 102. They may be prompted to download an application such as from an App Store at step 504 and launch the system 102 at step 508. At step 510, a test may determine if the user is new or returning. A new user may be prompted to register at step 512 where mobile device-specific and initial registration information may be captured along with acceptance or denial of terms and conditions. A test at step 518 may determine if registration was successful. If it was not, logical flow may proceed to step 520 where a registration exception process may be initiated. At step 522, a test may determine if the exception was resolved. If it was not resolved, registration may terminate at step 524. If the exception is resolved or if initial registration was successful, logical flow may proceed to registration confirmation at step 528 where users may opt-in or out of messaging and the user may populate a shopper profile. After either confirmation of a new user at step 528 or successful authentication of existingusers at step 514, logical flow may continue to step 530 where users can go to a customized home page at step 530. At the customized home page, user may view offers and offer details with or without a category filter. At step 532, users may select one or more offers for placement into a system 102 cart prior to going shopping for the product(s) of the offer(s). After purchasing the one or more products, the receipt is imaged in step 534, such as via taking one or more photos of it, scanning it, faxing it, or the like. The user may review the image at step 538. A test at step 540 may determine if the image is good. If the image is good, logical processing flow may continue to step 542 on FIG. 5b. If the image is not good, logical flow returns to step 534 for re-imaging. At step 542, the receipt image, or a digital receipt, may be submitted to the system 102. At step 544, the user is notified that the imaged or digital receipt was sent into the system 102 for optimization and textualization. At step 548, the OCR result or text from the digital receipt may be matched against the user's selected offer(s) using the system's 102 matching algorithm. After a review at step 550 of the one or more matches, a test at step 552 may determine if a match exception process may be triggered. If the outcome of the test is negative, logical processing flow may proceed to step 554 where the user may review the matches to identify if any matches were missed. At step 560, another test may determine if an match exception process should be triggered. If the outcome of step 560 is negative, logical processing flow may proceed to step 564 where the matched offers may be processed for payment. If the outcome of step 560 or step 552 is affirmative, a match exception management process may be triggered at step 558. Logical processing flow then continues to a test at step 562 to determine if the match exceptions were resolved. If the outcome at step 562 is negative, logical processing flow may continue to step 574 where the user is notified of the results, the offers are returned to the system 102, and the offer funds may be returned to the system 102 or the manufacturer. Logical processing flow may then proceed to an offer and manufacturer reconciliation process at step 578. If the outcome of the test at step 562 is affirmative or the outcome of step 560 is negative, logical processing flow may continue to step 564 where the matched offers may be processed for payment. A test at step 568 may determine if the user is registered for payment. If the outcome of the test at step 568 is negative, logical processing flow may continue to step 570 where the user may register for payment either with the system or with a third party. If the outcome of the test at step 568 is positive or after registration at step 570, payment may be made at step 572. Logical processing flow may terminate at step 578 with an offer and manufacturer reconciliation process.

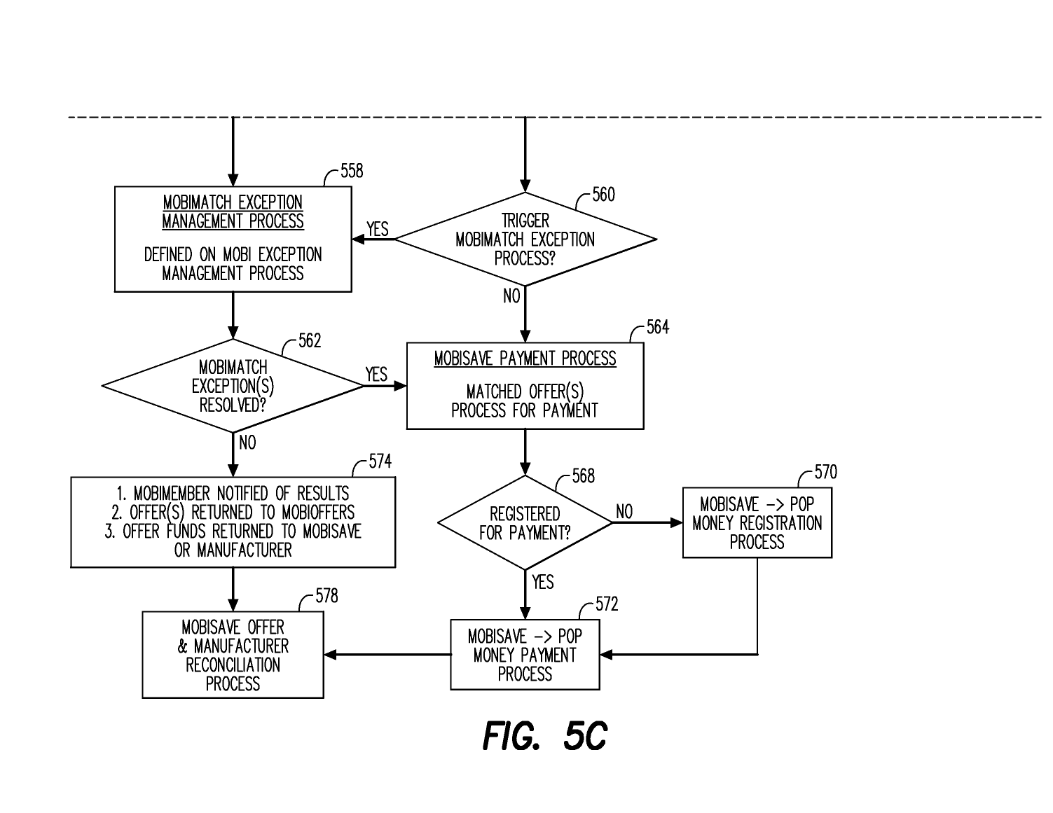

Referring now also to FIG. 6, the system may further include a reporting facility 124 that provides real-time tracking of offers and redemptions. Offer sponsors, marketers, and retailers may use a dashboard 138 to interface with the reporting facility 138 to view offer redemption tracking by any variable or measure, interface with the proof processor 110 to audit or confirm redemptions, interface with the rewards offer facility 122 to submit new offers, modify offers, delete offers, and the like, interface with a terminology database 130 to submit new terminology data for their products, modify or confirm existing data, or to delete data, interface with a user shopping database 132 to view all shopping behavior, not just behavior with respect to their products/offers, interface with a payment facility 112 to make payments, and the like. Manufacturers may use the dashboard 138 to examine data by region, metro, retailer, gender, age, product category, and the like. Manufacturers may use the dashboard 138 to examine total numbers served, offers selected, and offers redeemed. Manufacturers may use the dashboard 138 to obtain a trend report for redemptions. Manufacturers may use the dashboard 138 to examine a budget monitor, selected rate, redeemed rate and the like. Manufacturers may use the dashboard 138 to examine results by week, such as numbers served, selected, redeemed, and the like.

In an embodiment, users of the proof-of-performance verification system would not be required to search for paper coupons, clip coupons and present each coupon at checkout. Instead, this system does not require carrying individual coupons and does not require presenting them at checkout. Also, compared to traditional mail-in rebates, the user may quickly submit their proof electronically without having to fill out forms, enclose UPC codes, surrender their original receipt, pay for postage or visit the bank to cash or deposit small checks. The user may also receive notification of rewards within minutes rather than waiting weeks. The processing costs to the rewards sponsors, such as manufacturers, may be substantially reduced by automating the verification system and transmitting information and payments electronically.

Fraudulent use of digital incentives, such as home printed coupons, may be avoided because rewards are only given after verification. Also, the system may not be prone to counterfeiting, alteration or duplication of printed coupons because no self-printed material is used for actual verification. Further, the system may capture unique characteristics of each store's receipt, such as formatting, font, art, and the like, so that receipt counterfeits may be detected. Fraudulent use of newspaper coupons by retailers or individuals or organizations may be completely avoided in this system. The system may entirely circumvent retailer systems mitigating all problems associated with implementing any system that must interact with the retailers' own point-of-sale systems. This also means the system may be rapidly deployed and reward purchases made in any store including those that do not accept manufacturer coupons. In an embodiment, the system may capture information from the receipt, such as time, date, location, and transaction numbers of the receipt to detect duplicates. Having receipt information, such as the time and date, may also assure that the user has selected the offer first before purchasing or checking out. This assures offer sponsors that they are not rewarding purchases that were already made or based on found receipts. The system may track member behavior over time and examine outliers who may be perpetrating fraud. For example, the system may examine the frequency of receipt submission and the numbers of matches per receipt to identify potential fraud. The system may also sample receipts and check the originals with retailers to make sure there are no counterfeits.

In an example, a user may want to purchase a new camera from a specific manufacturer. The camera manufacturer, through the system, may offer the consumer $100 off the purchase of the camera made at any retailer via a savings certificate. Consumers, who may optionally have a membership in the system, may buy, for a fee, the $100 discount offer, such as in the form of a savings certificate, coupon, rebate, or the like. The discount offer may be purchased by the consumer on a website accessing the system or a mobile application interface to the system. Once the purchase of the specified camera may be made, a digital image of the receipt or a digital receipt may be submitted to the system using methods previously described herein, optionally along with an image, scan, swipe, tap, or manual entry of a registration card. The receipt and the optional evidence of a registration card may serve as a proof of purchase. The system would then recognize that they purchased the product associated with the offer via methods described herein and match the offer against the proof-of-purchase. In an embodiment, the discount offer may then be distributed to the user in the form of a $100 payment or credit. The payment may be sent by any means for making a payment, such as cash, check, direct deposit, credit, money order, gift card, mobile payment, and the like. The manufacturer may cover the $100 discount while the system may retain the fee. The benefit for manufacturers is they are doing rebates and providing discount offers without any processing or marketing costs and they may acquire customers because of the registration card.

In an embodiment, the offer may only be honored by the camera manufacturer if a threshold number of users purchase the specified computer.

In an embodiment, the system may enable giving and redeeming gift certificates for specific products. For example, a user may want to give a budding photographer a $100 gift certificate towards the purchase of a CANON camera. The receiver would be notified by the system that they have $100 waiting to be redeemed once they purchase the CANON camera. Once they purchase the CANON camera and provide proof-of-purchase as previously described herein, the gift certificate may be redeemed as a payment, credit, refund, or the like.

In an embodiment, a user shopping database 132 for future marketing efforts may be built from the receipt information captured. Since the entire receipt is being scanned, all of the purchase data may be stored. These sales data may be stored along with information regarding the store, the user, past purchase data, purchase behavior, redemptions history, and the like. For example, a manufacturer may be able to use purchase behavior to refine their offers, target their offers such as based on prior category purchases, eliminate offers, improve their offers, launch new products to early adopters, defend against private label, cross-sell based on lifestyle/tastes, find new product opportunities based on companion purchases, pantry load to build loyalty, reach heavy category/brand users, filter out less profitable bargain hunters, track brand switching and vulnerability, recruit search subjects quickly and inexpensively, and the like. In an embodiment, an advertisements database 134 may be included in the system 102. Manufacturers may upload advertisements to deploy to users accessing the system 102, accessing a specific offer, users requesting additional product details, and the like.

In an embodiment, a proof-of-performance verification system may include a software application either downloaded to a mobile phone, such as an IPHONE App, or other electronic processing device such as a personal home computer or laptop. The software may perform processing to facilitate verification of proof-of-performance. This processing may include receipt scanning, image enhancement, OCR conversion into searchable text, matching performance against requirements of offers, communicating with a remote processing facility that performance requirements have been met and thus having the remote processing facility provide rewards in any manner such as issuing checks, crediting accounts, making online payments, adding funds to a stored-value card or other system with writeable memory such as an RFID chip in a mobile phone, adding points or frequent flier miles to an account or any other desired manner of receiving the rewards. The system may also include using biometric finger print scanning to verify the actual user of the system as part of a registration for membership, offer selection and submission of proof.

In another embodiment, the proof-of-performance verification system 102 may not require physically imaging or scanning a receipt or other proof of performance. In this embodiment, performance data may be electronically transmitted to a mobile phone or other handheld device or directly to the rewards sponsor or the rewards sponsor processor and payment may be made directly to said handheld device which may contain a memory card such as an RFID chip. In this embodiment, actual itemized purchase data or other data held by the RFID chip in memory or other means may be transmitted to the remote location and used as proof-of-performance and said reward may be provided upon proof-of-performance by electronically communicating with the RFID chip and its payment system. For example, and without limitation, a shopper may use their mobile phone to scan product barcodes as they shop in a supermarket and then checkout by having the supermarket point of sale system scan the data collected in the mobile phone on checkout. The mobile phone may house an RFID chip which may be linked or may communicate to a bank or credit card account and the RFID chip may communicate payment information to the supermarket point-of-sale system. The itemized purchase information on that chip may also be used as proof-of-purchase for the above mentioned rewards system. The itemized purchase information would be sent from the mobile phone to the remote processing facility for verifying the purchase. The remote processing facility may then electronically communicate back to the mobile device and RFID chip which will then provide an award credit to the linked bank account or other reward repository as desired by the shopper.

The proof-of-performance verification system may be a centralized system that collects proof-of-performance data and images for later forwarding to the remote processing facility and can electronically match the offers against the proof-of-performance and capture for future use all other information contained on that receipt or other proof.

The proof-of-performance verification system may include a receipt scanner, camera, fax machine, or other device to capture an image and a display screen, such as an LCD or CRT, or mobile phone screen. The screen may have touch screen capability. The proof-of-performance verification system may include a two-way modem or other communications device hardwired or wirelessly connected to a network. The proof-of-performance verification system may include a keyboard or pin pad allowing the user to enter their identification information. The proof-of-performance verification system may include a card reader. The proof-of-performance verification system may include a reloadable stored-value card or other such card which may retain the incentive rewards for later use by the user of the system. The proof-of-performance verification system may include a facility to write to a stored-value card and or communicate incentive rewards to a central location for later use. The proof-of-performance verification system may include a payment facility to distribute the rewards.

In an embodiment, the proof-of-performance verification system may include a secure digital receipt (SDR) system to enable secure digital receipts, also referred to as paperless receipts or e-receipts, to be used for offer and rebate redemptions. For example, a shopper may have a choice of a printed paper receipt and/or having the receipt emailed or sent via SMS, MMS, and the like. In an aspect of the invention, a process for using the secure digital receipt (SDR) system may involve Traditional and Internet retailers agreeing to use the SDR system software at their checkouts. Shoppers may become a member of the SDR system and undergo a verification process to authenticate their identity, such as with personally identifiable information. At checkout, the shopper may request a secure digital receipt (SDR). The SDR may be in form of an image, such as a PDF or in text. The SDR may contain a “watermark” or some other means to prevent alteration, counterfeiting or duplication. The watermark may be in the form of a bar code, QR code, or the like containing information such as user ID, encryption device or image, encoded text, a date stamp, and the like. The SDR may also be associated with a unique sender ID, such as an email address or mobile phone number that identifies the user. The SDR system may require another form of ID such as fingerprint, eye scan, facial recognition or password to verify the identity of the user. The shopper may use the SDR in the proof-of-performance verification system as proof-of-purchase to redeem product rebates by emailing or using another digital or electronic method for submission. The SDR system may prevent shoppers from tampering, altering, duplicating or counterfeiting receipts. Such receipts may be used for rebate redemption or proof-of-purchase for returns.

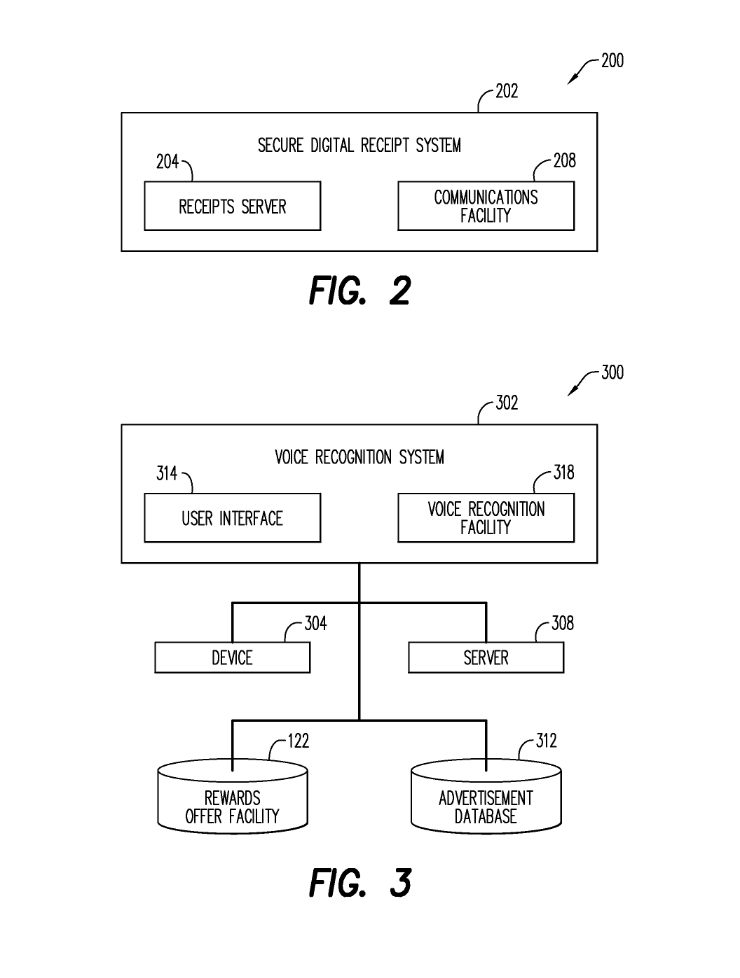

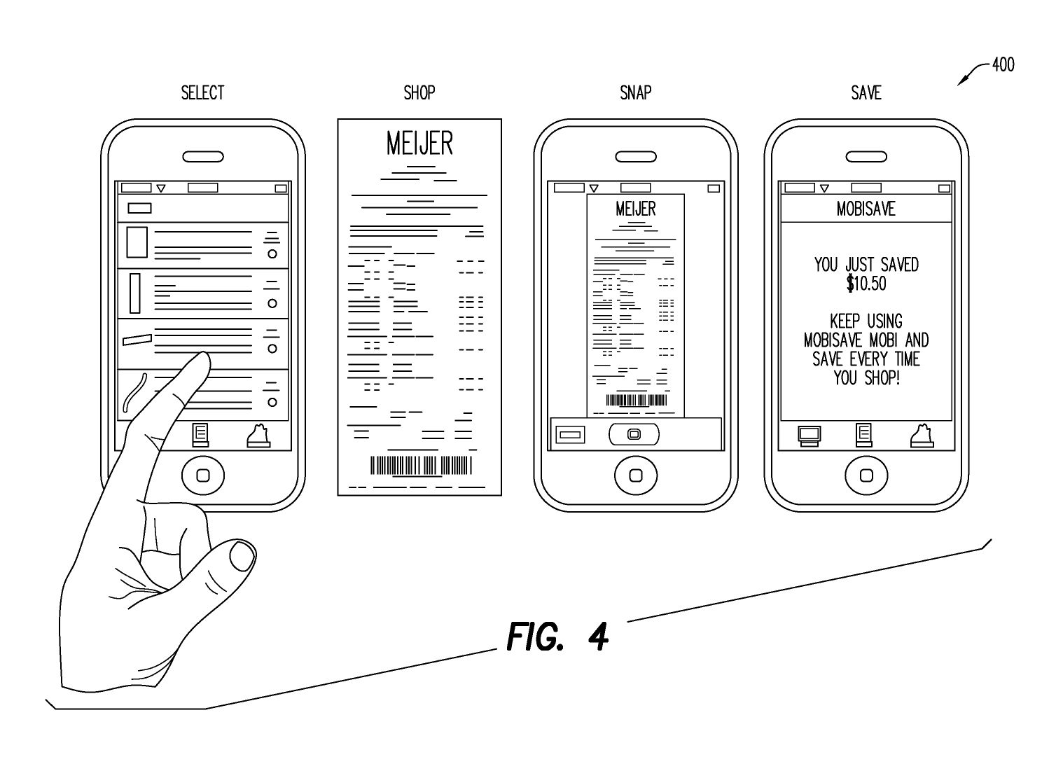

Referring to FIG. 2, a secure digital receipt system 202 may include a receipts server 204 that prepares a secure digital receipt and a communications facility 208 that delivers the secure digital receipt to a shopper.

In an embodiment, the proof-of-performance verification system 102 may include a voice recognition system 302 that may enable a user to speak into an electronic device 304, such as a computer, handheld device, mobile phone, and the like, to create a shopping list using voice recognition technology. The voice recognition system 302 may be a software application residing on the device 304 or on a server 308 including a user interface 314 and a voice recognition facility 318. The voice recognition facility 318 may recognize the spoken word as a product or brand name and create a shopping list including the recognized products and brands. In another embodiment, the shopping list may be generated from scanned bar codes. The shopping list may be printed or carried on the device into a store. In an embodiment, the shopping list may be transmitted to a shopping service that may then pick and pack the shopping list items. Using the user interface 314, the user may create a new shopping list, modify an existing shopping list, manually input new items, and the like.

In an embodiment, the proof-of-performance verification system 102 may determine if there are coupons or rebates or other purchase incentives available for the recognized items and then let the user know of their existence in any manner including, but not limited to, modifying the shopping list, sending text or email messages to the user, or any other method that communicates with the shopping list creator. For example, the proof-of-performance verification system 102 may use the voice recognition facility 318 to recognize a spoken word. Once the word is recognized, the spoken word may be searched in a database of coupons or rebates or other purchase incentives 310. If there is a match, the coupons or rebates or other purchase incentive may be communicated to the user. In an embodiment, the proof-of-performance verification system 102 may also send or display an advertising message related to the category, product or brand to the user. For example, the proof-of-performance verification system 102 may use the voice recognition facility 318 to recognize a spoken word. Once the word is recognized, the spoken word may be searched in a database of advertisements 312. If there is a match, the advertisement may be communicated to the user.

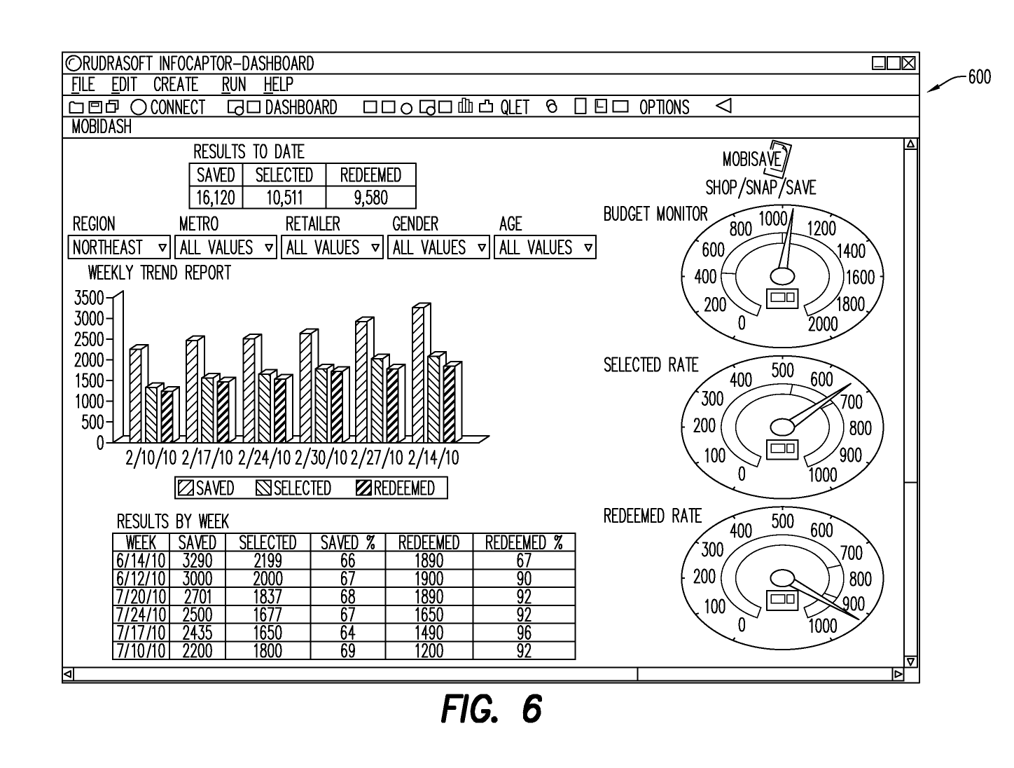

According to other aspects of this disclosure, and as generally illustrated in FIG. 7, a wellness promotion system may also or alternatively be provided. In particular, a system 700 that promotes healthy eating habits may be provided. The wellness promotion system may, like the proof-of-performance system described above, use images of paper purchase receipts, digital receipts or other means to verify purchases (i.e., food purchases) by system participants, and may award incentives and/or apply disincentives to the participants based on the verified food purchases to induce participants to engage in and maintain healthy eating habits, as reflected in the participants' purchasing habits. Thus the wellness promotion system 700 may operate as a wellness-incentive system.

Major functions of the wellness promotion system 700 may be implemented via a system computer 702. The system computer 702 may receive input from, and authorization for incentive funding from, one or more health promotion organizations 704. The latter may include, for example, health insurance plans; group medical practices, hospitals and other medical providers; employers that sponsor employee wellness programs; government and/or privately sponsored community health programs; and any other organization having a mission or interest to promote wellness and or healthy eating habits.

As in the case of the proof-of-performance system, grocery stores 706 may function as issuers of purchase transaction receipts. User devices 708 and/or apps on such devices may operate to capture images of the purchase receipts or otherwise operate to forward the purchase transaction receipts to the system computer 702. According to some embodiments, and as was the case in connection with the proof-of-performance system, the user devices 708 may be smartphones having cameras by which images of paper transaction purchase receipts are captured for forwarding to the system computer 702.

Major functional aspects of the system computer 702 may include an incentive/disincentive system program 710, a receipt processing program 712, an incentive accounting program 714 and an incentive disbursement program 716. Further, the system computer 702 may store a shopping results database 718, a participant database 720 and an incentive/disincentive database 722.

Participant enrollment software, which is not separately shown, may be provided in conjunction with the incentive/disincentive setting program 710. Participants may be enrolled in the wellness promotion system 700 via input to the system computer 102 from one or more of the health promotion organizations 704 (e.g., via batches of data loading participants/affiliated individuals from the health promotion organizations). In addition or alternatively, the participants may enroll individually via interaction with the system computer 702. For example, the participants may access a website hosted by the system computer 702 to facilitate their enrollment. In some embodiments, the participants may enroll via the website/system computer 702 into wellness programs sponsored by one or more of the health promotion organizations 704.

In some embodiments, a health promotion organization 704 may perform a health assessment on a participant and may establish healthy eating goals/guidelines for the participant. The health promotion organization 704 may transmit the eating goals/guidelines for the participant to the system computer 702 and may also indicate to the system computer 702 a level and/or duration of time of funding for incentives that the health promotion organization 704 will make available to induce the participant to adopt healthy eating habits. In some embodiments, the incentive/disincentive setting program 710 may set food purchase incentives and disincentives for the participant based on the input provided by the health promotion organization(s) 704. These incentives/disincentives may be reflected in data stored in the incentive/disincentive database 722 by the incentive/disincentive setting program 710. The incentive/disincentive data may be indexed in the incentive/disincentive database 722 in association with the name/participant identifier for the relevant participant. The incentive/disincentive data may reflect a diet strategy designed for the user, and may implement and/or reflect one or more rules intended to govern the user's food purchasing habits.

For example, the incentive/disincentive data may set forth an incentive of 10 cents per ounce of fresh fruit purchased by the participant during the first month of a wellness program, and an incentive of 15 cents per ounce of fresh vegetables purchased by the participant during the first month of the wellness program. These incentives may be reduced by half for the second month of the wellness program.

The incentive/disincentive program may set forth, for example, a disincentive of 25 cents per ounce for potato chips purchased by the participant throughout the program duration. Similar disincentives may apply to other snack foods, candy, baked goods, etc. In operation, disincentives activated by the participant's purchases may offset incentives the participant has earned through his/her purchases.

Many other types or examples or levels of incentives/disincentives may be applicable in a given situation or in various types of embodiments.

The receipt processing program 712 may operate similarly to receipt processing capabilities of the proof-of-performance system, but only with respect to identifying food purchases indicated by receipts submitted by participants.

The incentive accounting program 714 may compare the food purchases as identified by the receipt processing program 712 with the incentive/disincentive data stored for the relevant participant to determine what incentives and/or disincentives were earned/triggered by the participant's food purchases.

If the processing by the incentive account program indicates that a net incentive is due to the participant, disbursement of the incentive may be handled by the incentive disbursement program 716. Any one or more of the payment/disbursement techniques described above in connection with the proof-of-performance system may be employed in connection with disbursement of incentives in the wellness promotion system 700.

The results of the processing by the incentive account program 714 and records of the participant's overall food shopping activity may be stored in the shopping results database 718.

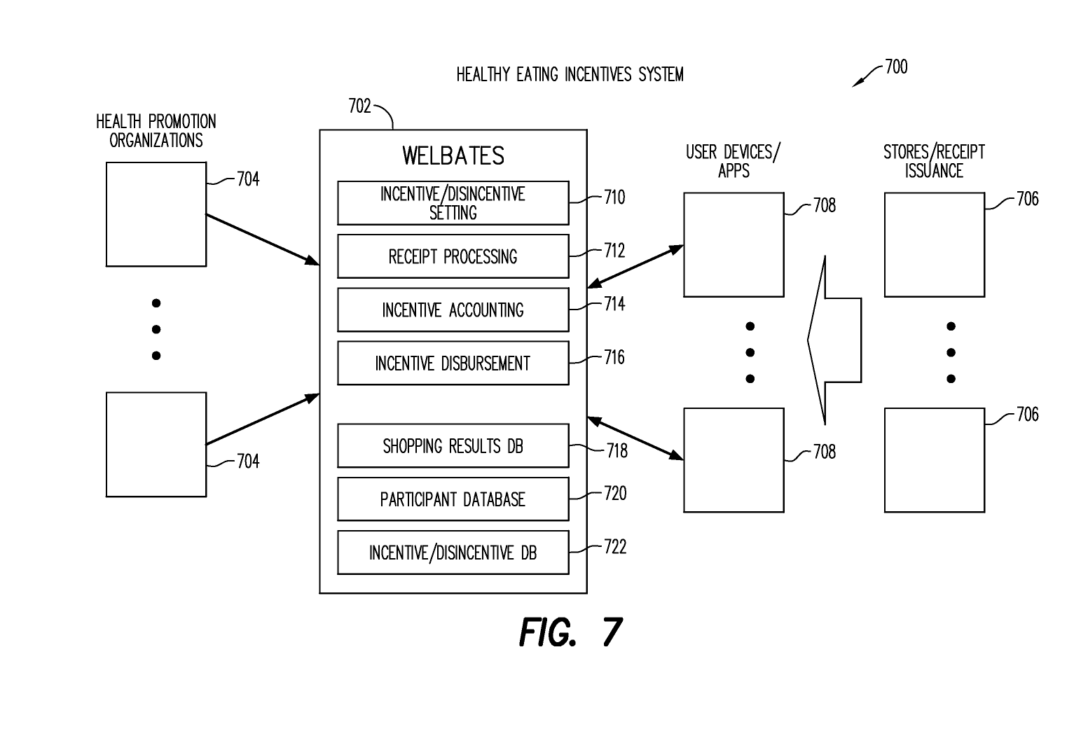

FIG. 8 is a block diagram that depicts an example embodiment of the system computer 702.

Referring now to FIG. 8, the system computer 702 may, in its hardware aspects, be constituted with typical mainframe computer and/or server computer hardware. Other example hardware embodiments are described below.

The system computer 702 may include a computer processor 800 operatively coupled to a communication device 801, a storage device 804, an input device 806 and an output device 808. The processor 800 may be in communication with the communication device 801, the storage device 804, the input device 806 and the output device 808.

The computer processor 800 may be constituted by one or more single or multi-core processors. Processor 800 operates to execute processor-executable steps, contained in program instructions described below, so as to control the system computer 702 to provide desired functionality.

Communication device 801 may be used to facilitate communication with, for example, other devices (such as one or more computers operated by the health promotion organizations 704, and numerous user devices 708). For example, communication device 801 may comprise numerous communication ports (not separately shown), to allow the system computer 702 to communicate simultaneously with a number of other computers and other devices, including communications as required to simultaneously handle numerous submissions of participant wellness programs and images of paper purchase transaction receipts.

Input device 806 may comprise one or more of any type of peripheral device typically used to input data into a computer. For example, the input device 806 may include a keyboard and a mouse. Output device 808 may comprise, for example, a display and/or a printer.

Storage device 804 may comprise any appropriate information storage device, including combinations of magnetic storage devices (e.g., hard disk drives), optical storage devices such as CDs and/or DVDs, and/or semiconductor memory devices such as Random Access Memory (RAM) devices and Read Only Memory (ROM) devices, as well as so-called flash memory. Any one or more of such information storage devices may be considered to be a computer-readable storage medium or a computer usable medium or a memory.

Storage device 804 may store software programs for controlling processor 800, such as the programs described above in connection with FIG. 7 (which programs are collectively represented by block 810 in FIG. 8). The programs comprise program instructions (which may be referred to as computer readable program code means) that contain processor-executable process steps of the system computer 702, executed by the processor 800 to cause the system computer 702 to function as described herein.

The programs may include one or more conventional operating systems (not shown) that control the processor 800 so as to manage and coordinate activities and sharing of resources in the system computer 702, and to serve as a host for application programs 810 that run on the system computer 702.

The storage device 804 may also store, and the system computer 702 may also execute, other programs, which are not shown. For example, such programs may include a reporting application, which may respond to requests from system administrators for reports on the activities performed by the system computer 702. The other programs may also include, e.g., one or more data communication programs, database management programs, device drivers, etc.

The storage device 804 may also store the databases referred to above in connection with FIG. 7, which databases are collectively represented by block 812 in FIG. 8.

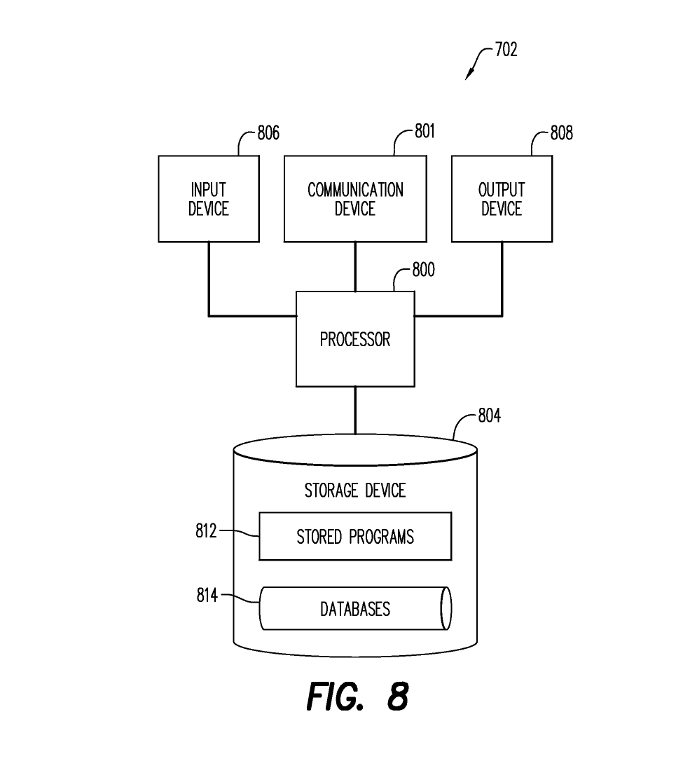

FIG. 9 is a block diagram that depicts a typical one of the user devices 708, particularly on the assumption that, in a particular case, the user device 708 is constituted by a smartphone that is running a suitable mobile app.

In one embodiment, the user device 708 may have a typical configuration and characteristics of a smartphone in its hardware aspects and also in many of its software aspects, except that the user device 708 may be programmed suitably to allow it to perform a role or roles in the wellness promotion system 700. In many, or perhaps all respects, the user device 708 may implement functionality—in regard to capture and forwarding of purchase transaction receipts—as described above in connection with the mobile device depicted in FIG. 4 and referred to in the above-description of the proof-of-performance system.

The user device 708 may include a housing 902. In many embodiments, the front of the housing is predominantly constituted by a touchscreen (not separately shown), which is a key element of the user interface 904 of the user device 708.

The user device 708 further includes a mobile processor/control circuit 906, which is contained within the housing 902. Also included in the user device 708 is a storage/memory device or devices (reference numeral 908). The storage/memory devices 908 are in communication with the processor/control circuit 906 and may contain program instructions to control the processor/control circuit to manage and perform various functions of the user device 708. As is well-known, such functions include operation as a mobile voice communication device via interaction with a mobile telephone network (not shown). Further conventional functions include operation as a mobile data communication device, and also as what is in effect a pocket-sized personal computer, via programming with a number of application programs, or “apps”. (The apps are represented at block 910 in FIG. 9, and may in practice be stored in block 908, to program the processor/control circuit 906 in myriad ways.) The above-referenced mobile communications functions are represented by block 912, and in addition to programmed control functions, the mobile communications functions also rely on hardware features (not separately shown) such as an antenna, a transceiver circuit, a microphone, a loudspeaker, etc.

In addition, as is commonly the case with smartphones, the user device 708 may include a camera 914, which may provide digital images for storage in and/or processing by the user device 708. As will be appreciated in view of the above-descriptions of capturing images of paper purchase transaction receipts, the camera 914 may be operated for that purpose in connection with aspects of the wellness promotion system 700.

From the foregoing discussion, it will be appreciated that the blocks depicted in FIG. 9 as components of the user device 708 may in effect overlap with each other, and/or there may be functional connections among the blocks which are not explicitly shown in the drawing.

It has been posited that the user device 708 may be embodied as a smartphone, but this assumption is not intended to be limiting, as the user device 708 may alternatively, in at least some cases, be constituted by a tablet computer that has mobile communication capabilities or by other types of mobile computing devices.

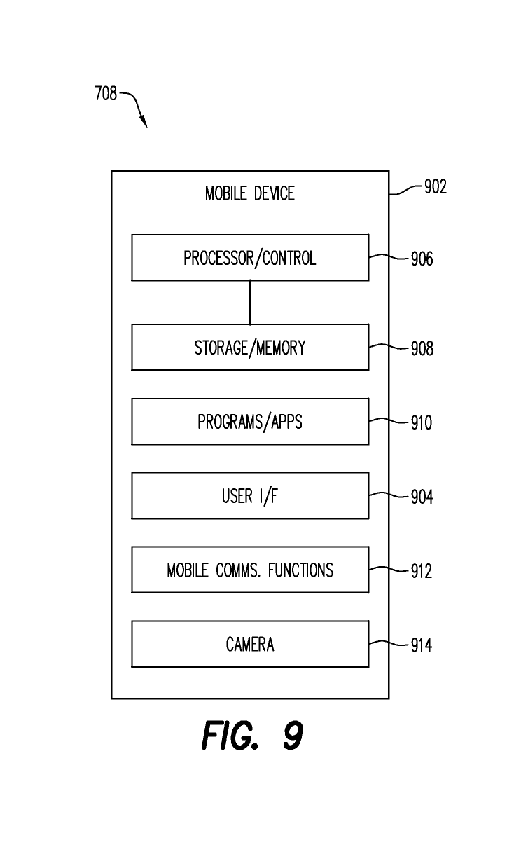

FIG. 10 depicts a process that may be performed in the wellness promotion system 700.

At 1002 in FIG. 10, a participant/user is registered/enrolled in the wellness promotion system 700. Among other possibilities, this may occur by the user interacting with the system computer 702 via a website hosted by the system computer 702, or may occur by one of the health promotion organizations communicating with the system computer 702 to enroll the user.

At 1004, an evaluation of the user's health may occur. For example, such an evaluation may be performed by a health services provider or by a community health organization. Assuming the results of the health evaluation so indicate, the organization that performs the evaluation may determine that changes are in order in the user's eating habits. Therefore, the entity that performed the health evaluation may develop (block 1006, FIG. 10) a diet strategy for the user to guide the user to improved eating habits. At 1008, either the entity that developed the diet strategy and/or the system computer 702 may translate the diet strategy into a set of incentives and/or disincentives to financially reward and/or penalize the user to guide the user toward compliance with the diet strategy. At 1010, the wellness promotion system 700 may operate to implement and follow up on the user's compliance with the diet strategy through application of the incentives/disincentives to the user.

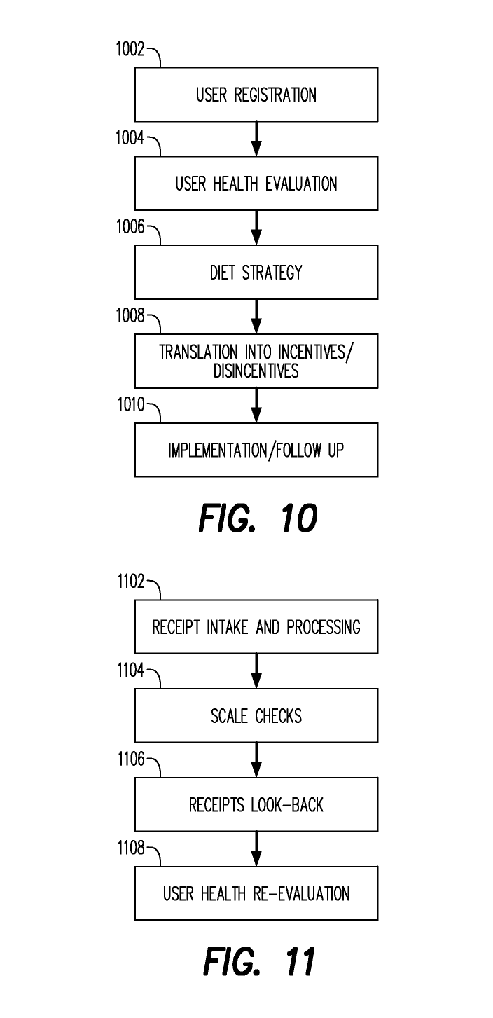

FIG. 11 depicts a process that may include aspects of block 1010 in FIG. 10.

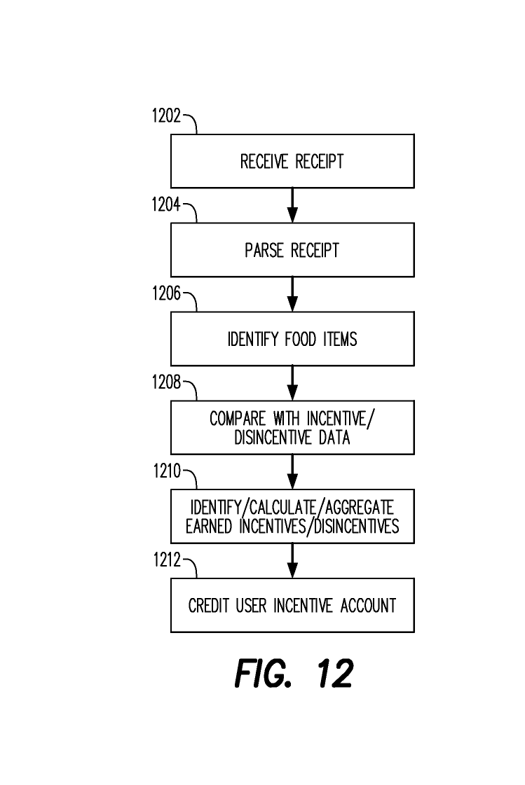

At 1102 in FIG. 11, the system computer 702 may receive images of food purchase transaction receipts and process them by determining the items of food purchases represented by the receipt images, determining the identity of the user who submitted the receipt images, comparing the food purchase items with the relevant incentive/disincentive data for the user in question, determining applicable incentives and/or disincentives, and disbursing a net incentive (if any) to the user. Further details of this block will be described below with respect to FIG. 12.

At 1104, the system computer 702 may receive a transmission from a user device 708 to provide a report of the results of the user weighing himself/herself on the user's home/bathroom scale. For example, the data transmitted from the user device 708 may include data that identifies the user, plus an image captured by the user device 708 that shows the numerical reading on the scale indicated when the user weighs himself/herself. The system computer 702 may then use numerical/character recognition processing to translate the scale reading image into data that represents the result of the scale reading (i.e., the user's weight at the time the image was captured). In some embodiments, the data transmitted by the user device 708 indicates the date and time when the image was taken.

In some embodiments, the system computer 702 stores data concerning the user's weight and the date the weight reading was taken to track changes in the user's weight over time, and possibly to guide and track the effectiveness of, and adherence to, the diet strategy that had been established for the user. In some embodiments, the results of one or more scale readings transmitted to the system computer 700 may serve as an input to a process in which the incentive and/or disincentive data for the user is modified. The scale reading data stored by the system computer 702 may reflect the information provided by the user device, including data obtained from the scale reading image as described above.

At 1106, the system computer 702 may review data obtained over a period of time from food purchase transaction receipt images submitted by a particular user. The system computer 702 may apply one or more algorithms to the data under review to detect patterns of compliance or noncompliance, and/or to detect anomalies that may indicate possible fraud or deception by the user relative to the incentive program established for the user. If anomalies are detected, further steps, possibly including investigation, may be performed.

At 1108, and at some time after the healthy eating program began for a particular user, one of the health promotion organizations 704, for example, may arrange for a re-evaluation of the user's health. The results of the re-evaluation may guide further steps taken with respect to the user and/or the food purchase incentives program for the user. For example, if the user's health has improved (e.g., the user has reached a goal for losing weight), the food purchase incentive program may be concluded, or the food purchase incentive program may be continued in a modified form with a revised goal of maintaining the user's healthy eating habits and keeping his/her weight stable. In cases where the health re-evaluation indicates a lack of progress, or insufficient progress, the food purchase incentive program may be continued and/or modified so as to attempt a different approach to assist in guiding the user to a desired health improvement goal. The system computer 702 may accordingly store revised incentive and/or disincentive data with respect to the user, to be applicable to further submissions of food purchase transaction receipts by the user.

FIG. 12 depicts details of the process step shown at 1102 in FIG. 11. At 1202 in FIG. 12, the system computer 702 may receive an image of a paper food purchase transaction receipt submitted by a user from the user's user device 708. At 1204, the system computer 702 parses the receipt image to detect food purchases reflected in the receipt and at 1206 the system computer 702 may identify purchased food items reflected in the receipt. This may involve OCR processing, and/or comparison of receipt items to known abbreviations (or suspected abbreviations) referring to food items. This may further involve categorizing food purchase items (e.g., apples, grapes, bananas, etc. may be categorized as “fresh fruit”; broccoli, cauliflower, carrots and celery, etc., may be categorized as “fresh vegetables”). As to purchases of fresh produce, the system computer 702 may also analyze the receipt to determine the quantity (e.g., the count or weight) of the produce that was purchased, as reflected in the receipt image.

At 1208, the system computer 702 may compare the detected food purchase items with the stored incentive/disincentive data for the user to determine whether food purchases have occurred that trigger accrual of incentives or application of disincentives with respect to the healthy eating program that has been established for the user. The results of step 1208 may feed into step 1210, at which the system computer 702 identifies and/or calculates applicable food purchase incentives/disincentives. For example, the amount of incentive or disincentive determined by the system computer 702 with respect to a particular food item purchased may depend on the precise identity of the food item, and/or the category to which the food item has been assigned, and/or the quantity of the food item represented by the particular food purchase receipt line item.

At 1212, the system computer 702 may credit to a user's account a total incentive (net of a total of disincentives), as calculated and/or determined by the system computer 702 at 1210. In some embodiments, incentives earned by the user may be totaled monthly and credited against his/her health insurance premium bill. This may be a particularly effective way of motivating users to participate in the wellness promotion system and to improve their eating habits. This mode of applying incentives may be especially suitable in cases where the or a health promotion organization is a health insurer or the like.

To give a concrete and somewhat simplified example of how the process of FIG. 12 may proceed, the following should be considered.

Assume that the system computer 702 has received an image of a paper shopping transaction receipt from User A. The system computer 702 applies OCR processing and other processing to detect the content (in text form) of line items on the receipt. The system computer 702 may also take steps to verify the authenticity of the receipt, including measures described above in connection with the proof-of-performance system. The system computer 702 may disregard all line items in the receipt that are not food items. The system computer 702 may, if necessary, translate abbreviations in the line items into the full text names for the items purchased and/or may match abbreviations with such names as stored in a food item names database.

It will be assumed for purposes of this example that there are three food item purchases indicated by the receipt, as processed by the system computer 702: (1) a pound of broccoli; (2) three apples; and (3) a 3 ounce bar of chocolate.

As to the broccoli item, the system computer 702 may apply a classification rule to determine that broccoli falls into the category of cruciferous vegetables. The system computer 702 may then search the incentive/disincentive data stored for User A and determine that User A is to receive an incentive of 25 cents per pound of cruciferous vegetables that User A purchases. Accordingly, the system computer 702 determines that User A has earned a 25 cent incentive for the purchase of the broccoli.

As to the apples, the system computer 702 may search the incentive/disincentive data stored for User A and determine that User A is to receive an incentive of 10 cents for each apple purchased. Accordingly, the system computer 702 determines that User A has earned a 30 cent (3 times 10 cents) incentive for the purchase of the apples.

As to the chocolate bar, the system computer 702 may search the incentive/disincentive data stored for User A and determine that a disincentive of 20 cents is applicable to User A for the purchase of more than 2 ounces but not more than 4 ounces of chocolate. Accordingly, the system computer 702 determines that a disincentive of 20 cents is to be applied with respect to User A's purchase of the chocolate bar.

Noting that the above is a simplified example, it should be understood that the actual incentive earned in a typical shopping visit may be several dollars or more. Over a month's time, the incentive earned may mount up significantly. As noted above, monthly incentives earned may be credited, in some embodiments, against the user's health insurance premium bill. An incentive applied in this way may be a powerful motivator to obtain user participation in, and compliance with, a wellness promotion program.

The resulting net incentive determined by the system computer 702 with respect to the purchase transaction reported by the current receipt is accordingly 35 cents (25 cents plus 30 cents less 20 cents). The system computer 702 accordingly causes 35 cents to be credited to the incentive account of User A.

The wellness promotion system 700, as described above and in connection with FIGS. 7-12, may provide financial incentives to users/participants to improve their diets and eating habits, by rewarding the participants for purchases of healthy foods, while offsetting incentive rewards with respect to purchases of food items that are not consistent with healthy eating. The incentive system may operate with high efficiency, since the users may readily report food purchases with easily captured and transmitted images of food purchase transaction receipts. Moreover, efficiency may be further provided by the automatic receipt, parsing and interpretation of the purchase receipts by the system computer 702, leading to automatic calculation and crediting of incentive payments.

A health promotion system such as that described above may be an effective vehicle for investment of financial resources with a goal of improving health and eating habits among particular groups or communities or populations.

In addition, the incentive program as described above, may allow for capture and storage of food purchase data, over time, for each program participant. This may allow for machine and/or human review and analysis of the participants' food purchasing habits, either individually or collectively, which may allow for improved understanding of individual and group food purchasing behavior and possible modification of strategies and approaches, as well as personalized counseling, to improve practices for promotion of healthy eating and wellness.

For the most part, the above discussion of the health promotion system 700 has assumed that reporting of food purchases was accomplished by submission of images of paper food purchase transaction receipts. However, other forms of reporting may additionally or alternatively be employed. For example, secure digital receipts (as discussed above in connection with the proof-of-performance system) may be employed (e.g., issued in electronic form by grocery stores and relayed to the system computer 702 from user devices 708). Other forms of electronic receipting and/or direct reporting from grocery stores (e.g., without inclusion of non-food items in the reports) to the system computer 702 may also be used. In the latter case, the report from the grocery store may be prompted by submission at checkout of the user's wellness promotion program identification card to the store POS terminal.

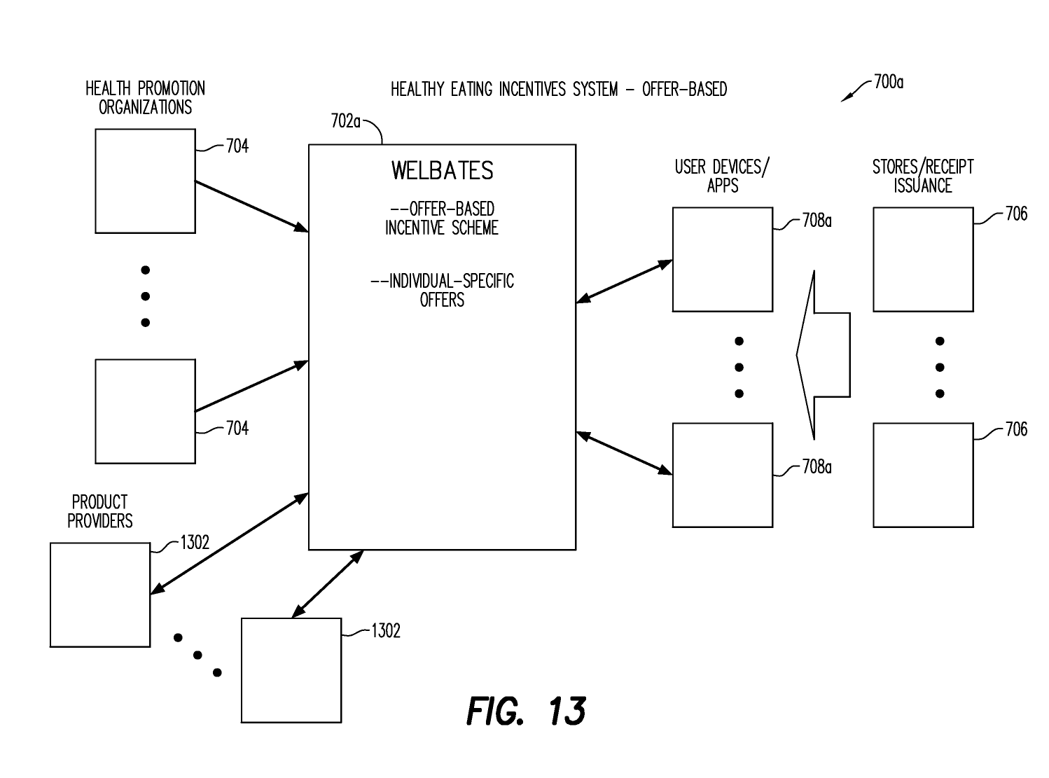

FIG. 13 is a block diagram that depicts an alternative embodiment of a health promotion system (the latter being generally indicated in the drawing by reference character 700a). The health promotion system 700a of FIG. 13 may incorporate additional elements of the proof-of-performance system 100. For example, in the health promotion system 700a, the diet strategy for a user/participant may be translated into individually tailored product purchase rewards offers, which may be funded, at least in part, by both one or more health promotion organizations and/or food product providers 1302. In the health promotion system 700a, as in the proof-of-performance system 100, the user may be required to select an offer prior to purchase in order to be rewarded for the corresponding purchase. This may aid in minimizing possible abuses, such as submission of old purchase receipts obtained by program participants from third parties.

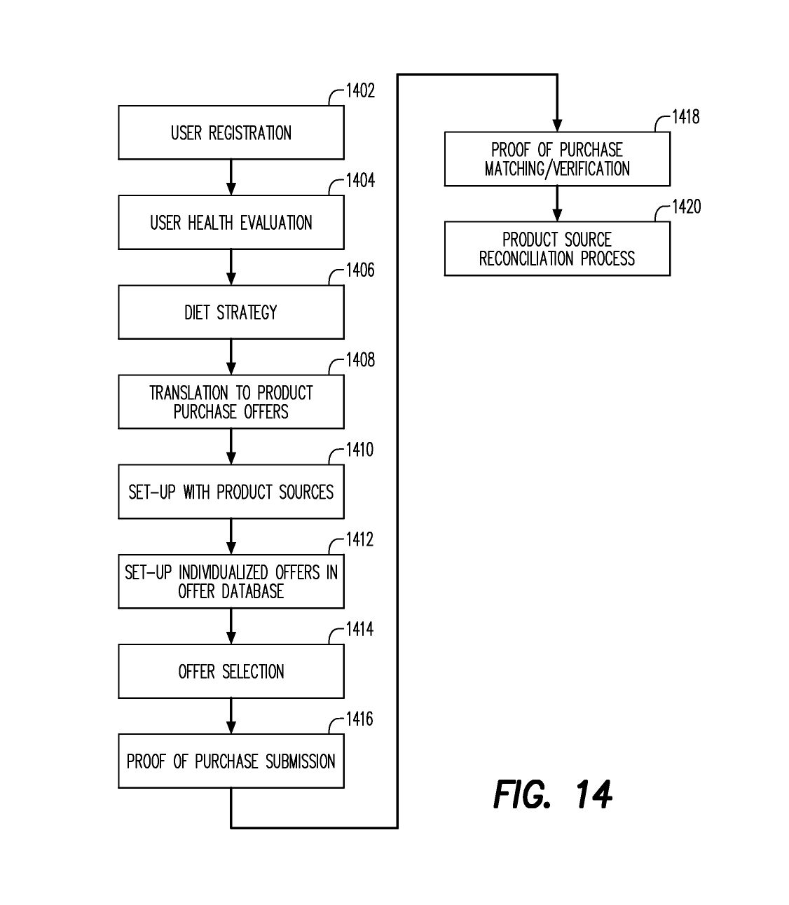

A major component of the health promotion system 700a is a system computer 702a. The system computer 702a may resemble the system computer 700 described above in a number of respects, including—for example—the hardware architecture and components described above in connection with FIG. 8. The programming of the system computer 702a may differ in some respects from the programming of the system computer 702, such that the system computer 702a provides at least some of the functionality described in the present description of the health promotion system 700a. Aspects of the functionality provided by the system computer 702a will be understood from the description below relating to FIG. 14.

As to the user devices 708a, the latter may in many respects resemble the user devices 708 described above. However, the programming of the user devices 708a may differ from that of the user devices 708. For example, the user devices 708a may run an app that facilitates the user's reviewing and selecting offers that have been individually designed and targeted for the user in support of incentivizing the user to adhere to a diet strategy created for the user to address his/her health problem(s).

Regarding both the system computer 702a and the user devices 708a, functionality similar to that described above with respect to blocks 530 (FIG. 5A) and 532, 548, 554 (FIG. 5B) and 564, 574 (FIG. 5C) (plus related functions) may be implemented, though with at least some offers made available to the user having been individually targeted to the user based on a diet strategy created for the user.

In some embodiments, all offers available to the user are food product purchase offers for food products that the user is to be encouraged to buy according to the diet strategy designed for him/her. In other embodiments, the system may make other types of offers also available to the user. In some embodiments, in the latter situation, the system computer 702a may screen out food product offers (that are available generally to system participants) in the cases of such offers as promote purchase of food items that the diet strategy discourages the user from consuming. That is, the system computer 702a may make unavailable to the user otherwise-generally-available food product offers that are inconsistent with the diet strategy designed for the user.

FIG. 14 is a flow chart that depicts an example process that may be performed in the health promotion system 700a of FIG. 13.

At 1402, a user may be registered/enrolled in the health promotion system 700a. This may involve, for example, the user interacting with a website hosted by the system computer 702a and/or enrollment of the user by a health promotion organization 704 that is concerned about maintaining or supporting the user's health. Moreover, processing at 1402 may also involve downloading a suitable app (e.g., a “Welbates” app) to the user's user device 708a.

At 1404, the user's health may be evaluated. At 1406, if necessary, a diet strategy may be designed for the user to promote the user's well-being and/or to address one or more specific health problems detected at 1404.

At 1408, the system computer 702 may translate the diet strategy for the user into a set of food product purchase offers to be individually targeted to the user. In some embodiments, the set of offers may reflect funding and/or guidance from one or more of the health promotion organizations 704. It will be appreciated that the offers may all provide financial incentives to the user to purchase foods that support the diet strategy designed for him/her at 1406.

At 1410, the system computer 702a may automatically (e.g., based on prior arrangement), set up co-sponsorship of one or more offers by sources of the food products that the user is to be encouraged to consume. For example, such food product sources may be growers, distributors and/or farm cooperatives that sell or promote sale of fresh fruits and vegetables or other health-promoting food products. Funding by the food product sources may supplement funding from the health promotion organizations so that an enhanced reward may be provided to the user for selecting and fulfilling the food product purchase offer in question.

At 1412, the system computer 702a may set up individually targeted offers, intended for and available only to the particular user, with the offers stored in a suitable database and accessible for viewing and selection only by the particular user.

For example, an offer may provide the user with a 50 cent reward/rebate for purchasing a pound of a certain brand of grapes; funding for the reward may be split between a health promotion organization and the seller/distributor of that brand of grapes. Similar offers may be provided for specific brands of other fruits or vegetables. In cases where the co-sponsor is an association of all growers of a particular type of produce, the offer may not be tied to purchase of a particular brand of that type of produce. In some embodiments, a co-sponsor may be a chain of retail stores that wishes to promote its offerings of healthy foods.

At 1414, offers are presented to/searched by the user and then certain ones of the offers are selected by the user. This may occur through interaction between the user's user device 708a and the system computer 702a. In some embodiments, the system computer may store a record of the user's selection of offers, including the date and time when the selection of each offer occurred. In some embodiments, as noted above, at least some of the offers may be offers generated specifically for, and available only to, the user. In some embodiments, all of the offers available for searching and selection by the user may be food purchase offers targeted specifically to the user to support the diet strategy designed for the user. In many respects, the processing at 1414 may resemble the processing at 530 in FIG. 5A, as illustrated in the left-most panel in FIG. 4.

At 1416 in FIG. 14, proof of purchase/proof of performance occurs with respect to selected articles. From previous description, it will be understood that the user has gone shopping and has purchased at least one or more of the food products that were the subject of the offers selected by the user at 1414. It will also be appreciated that the user has received (in some embodiments) a paper transaction receipt from the store at which he/she did the shopping. The processing that occurs at 1416 may resemble the processing at 534 and 542 in FIG. 5B (and related processing), as illustrated in the two center panels in FIG. 4. I.e., the user may capture an image of the paper transaction receipt and transmit the receipt image to the system computer 702a, using the user device 708a.

At 1418, the system computer 702a may parse and interpret the receipt image and match line items in the receipt image with offers that the user selected at 1414. The processing at 1418 may resemble the processing described above in connection with blocks 544 and 548 in FIG. 5B and related processing. The system computer 702a may read the time and date of purchase from the receipt image and confirm that the time and date of purchase is later than the stored time and date of selection of the matching offers.

In some embodiments, the processing of FIG. 14 may also include processing like that illustrated at block 554 in FIG. 5B such that the user is notified of which offers the system computer 702a matched to the receipt, and the user is given an opportunity to point out and be rewarded for offers that should have been matched but were not.

The match verification step 1418 may also be understood to involve payment of rewards to the user, e.g., in one or more of the ways described above in connection with the proof-of-performance system.

Block 1420 in FIG. 14 may be taken to resemble the processing at block 578 in FIG. 5C, in that—to the extent matched and paid-off offers were sponsored or co-sponsored by food product sources—such sources are charged for the amount of funding for which they are responsible relative to the matched offers.

As in previous systems described herein, the health promotion system 700a is not limited in its receipt processing and intake to processing of images of paper receipts. Thus, for example, the health promotion system 700a may receive secure digital receipts, as described above, or any other type of receipt that was referred to as usable in the proof-of-performance system 100.

The health promotion system 700a may be deemed a hybrid of the health promotion system 700 and the proof-of-performance system 100 described above. Moreover, in further embodiments, a hybrid of the health promotion systems 700 and 700a may be implemented. In the latter hybrid system, a user may both receive rewards for satisfying selected food product purchase offers, and may receive incentives based on comparing food product purchases with stored incentive data. In some embodiments, the same product purchase may earn both a reward that corresponds to a selected offer and an incentive that corresponds to stored incentive data that relates to that product (the latter as per the sort of process depicted in FIG. 12). In some embodiments, a user may—with respect to one line item on a submitted food purchase transaction receipt—earn a reward that corresponds to a selected offer, while for another line item on the same receipt, the user may become entitled to an incentive (e.g., as per the process of FIG. 12) or a disincentive may be applicable due to the latter line item. If a disincentive is applicable, it may at least partially offset the reward from the selected and fulfilled offer.

In some embodiments of the health promotion systems described above, gamification techniques may be employed to increase user engagement and participation in the system. For example, the user device app(s) that support the user activities with respect to the health promotion system may include one or more game elements. For example, the app(s) may have one or more mobile device games included in their functionality; submission by the user of food purchase receipts and/or the number of food purchase line items submitted may result in the user gaining advantages/benefits in the associated game(s). In some embodiments, the gamification elements may have real world effects. For example, for every ten food purchase transaction receipts submitted, the user may be entered once in a lottery for a valuable prize or prizes. In some embodiments, the relevant mobile app(s) may feature display elements that present the user's progress/participation in a manner that resembles game-like elements. For example, a graphical display on the user device, in bright colors, may present one or more of: (a) incentives earned in the current month; (b) improvements in the user's food buying habits; (c) the user's degree of participation, as indicated for example by number of receipts uploaded to the system, and/or the number of food items reported.

In some embodiments, the user device app(s) relevant to the system may include features to permit the user to create a shopping list and to submit the list to the system computer 702 to have the system computer 702 provide a score that indicates either or both of (a) an overall evaluation of how well the shopping list implements the diet strategy designed for the user; and (b) what amount of incentives would be earned by a submission of a shopping visit receipt that mirrored the shopping list.

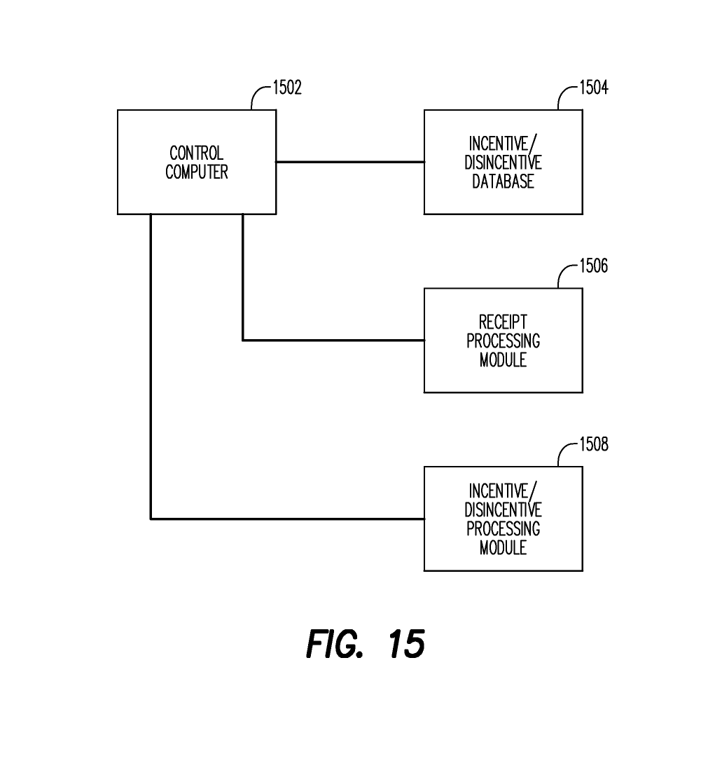

FIG. 15 may be understood as depicting another way of viewing the system computer 702 of FIG. 7 and/or another way of arranging for at least some of the functionality of the system computer 702. Block 1502 in FIG. 15 represents a control computer. An incentive/disincentive database 1504 is accessible by the control computer 1502. The incentive/disincentive database 1504 may resemble the database 722 depicted in FIG. 7.

Continuing to refer to FIG. 15, a receipt processing module 1506 may be operatively coupled to the control computer 1502. The receipt processing module may provide receipt processing functionality such as that described above in connection with the system computer 702.

An incentive/disincentive processing module 1508 may be operatively coupled to the control computer 1502. The incentive/processing module 1508 may determine/calculate/disburse incentives in accordance with the above discussion of health promotion system 700 and may also apply disincentives as described above in connection with the health promotion system 700.

In any of the health promotion systems described herein, users may be grouped together and incentives and/or rewards for healthy food purchase choices may be enhanced when higher proportions of the group are compliant with good food shopping habits.

In embodiments described above, users earn incentives by demonstrating their purchases of healthy foods in compliance with a wellness incentive program. In addition or alternatively, in some embodiments, users may earn incentives by achieving improvements in follow-up medical examinations/test results. In some cases, for example, the incentives for such improved results may be applied as discounts from and/or credits against health insurance premiums. In some embodiments, health insurers may track favorable effects of healthy buying programs on their claim experience and may calculate, design and/or award incentives accordingly. In some embodiments, users may be provided with periodic reports detailing how much money they have saved by complying with healthy purchase programs and/or achieving improved medical examination results.

In some embodiments, the user may be incentivized to engage in physical activity. One or more physical activity goals may be set for the user. The goal(s) may include, for example, an average number of steps walked per day and/or an average amount of stair-climbing per day. Compliance with the physical activity goal(s) may be detected/monitored via data generated by/received from a wearable computing device such as a smartwatch. Thus, in some embodiments, a wellness promotion system may include aspects of the so-called “Internet of Things”. Incentives to be awarded to the user for compliance may include (but are not limited to) credits against and/or reductions in health insurance premiums.

In some embodiments, the wellness promotion system may process food purchase receipts that represent purchases via the U.S. government sponsored “Supplemental Nutrition Assistance Program” (SNAP). Receipts for SNAP purchases may be identified by the system computer and additional incentive data/rules may be applicable to such purchases. For example, the incentive rules applicable to SNAP purchases may provide additional incentives to promote cost-effective purchasing habits directed toward healthy eating choices.

In embodiments described herein, the user's product purchases may be reported by the user scanning paper purchase receipts and transmitting images of such receipts to the system computer 702. It has also been indicated that secure digital receipts and/or reports from retailers may provide the system computer 702 with data concerning the user's purchases. Still another alternative technique may be used in conjunction with retailer customer loyalty programs that store data concerning users' purchases. According to this alternative technique, the retailer may permit access to its customer loyalty program purchase data by an automatic search program (e.g., a “BOT”) associated with the wellness promotion system. The BOT may scrape relevant purchased items data from the retailer's database and provide the results to the system computer 702.

In wellness promotion programs described herein, incentives and/or offers may be provided to promote healthy food purchasing habits. In addition or alternatively, a wellness promotion program—in some embodiments—may incorporate incentives and/or offers that promote purchasing of health related nonfood items such as sunscreen, mouthwash and/or other oral care items, etc.

One or more health and/or diet education programs may supplement the systems of food purchase rewards/incentives/disincentives described above. In some embodiments, the user devices 708/708a may include an app that allows the user to scan a product code/barcode on a food product in the grocery store aisle to cause the device to present a dashboard display that illustrates one or more nutritional/dietary characteristics/aspects of the food product. At least part of the dashboard may be in a “heat map” format. The dietary/nutritional aspects may include one or more of (a) salt content; (b) types of fat; (c) sugar content; (d) calorie concentrations; (e) vitamins; (f) use of additives; and (g) level of processing.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
receiving a receipt from a retail store purchase;
comparing contents of the receipt with wellness incentive and/or disincentive data; and
updating a user's incentive account based on a result of the comparing step.

2. The method of claim 2, wherein the receipt is received in the form of an image of a printed receipt;
the method further comprising:
converting the image to text.

3. The method of claim 1, further comprising:
generating said incentive and/or disincentive data based on a characteristic of the user.

4. The method of claim 1, further comprising:
compiling data from a plurality of receipts submitted by the user; and
detecting anomalies in the compiled data.

5. The method of claim 1, further comprising:
receiving from the user an image of a weighing scale;
analyzing the image of the weighing scale to determine the user's weight at a time the image of the weighing scale was generated; and
updating the incentive and/or disincentive data based on the user's weight as determined from the image of the weighing scale.

6. The method of claim 1, wherein the retail store purchase includes purchases of food items.

7. The method of claim 1, further comprising:
receiving data from a device worn by the user;
comparing the received data with at least one physical activity goal for the user; and
awarding an incentive to the user in cases where the received data indicates the user has achieved the at least one physical activity goal.

8. The method of claim 7, wherein the device worn by the user is a smartwatch.

9. The method of claim 1, wherein the incentive and/or disincentive data incorporates an incentive rule that promotes purchases of health-related non-food items.

10. A wellness-incentive system comprising:
a computer storing a database, the database containing incentive and/or disincentive data;
a receipt processing module configured to process food purchase receipts; and
a determination module operatively coupled to the computer and to the receipt processing module, the determination module configured to (a) compare contents of food purchase receipts with incentive and/or disincentive data contained in the database;
and (b) determine consumer incentive and/or disincentive results based on said receipt contents and said incentive and/or disincentive data.

11. The system of claim 10, wherein the receipt processing module is configured to receive images of paper food purchase receipts and convert the images to text.

12. The system of claim 10, wherein the receipt processing module is configured to receive electronic receipts generated by food merchants.

13. A method comprising:
receiving an image of a purchase transaction receipt;
translating the image into purchase transaction text data;
determining food purchases by a user from the text data;
comparing the food purchases with food purchase rules that apply to the user;
updating the user's incentive account based on the rules and the food purchases; and
disbursing a benefit to the user from the incentive account.

14. The method of claim 13, further comprising:
informing the user of a change in the rules.

15. The method of claim 13, further comprising:
reporting the user's compliance with the rules.

16. The method of claim 13, further comprising:
receiving a product code from the user, the product code representing a food product;
responding to the product code by generating a mobile dashboard indicative of nutritional aspects of the food product; and
sending the mobile dashboard to the user's mobile device.

17. The method of claim 16, wherein the nutritional aspects include one or more of (a) salt content; (b) types of fat; (c) sugar content; (d) calorie concentrations; (e) vitamins; (f) use of additives; and (g) level of processing.

18. The method of claim 17, wherein at least part of the mobile dashboard includes a heat map indicative of at least one of the nutritional aspects.

19. A method comprising:
receiving, in a computer, a request for offers from a user;
determining that the computer stores food offers authorized specifically and individually for the user, said food offers sponsored at least in part by a wellness promotion organization;
presenting said determined food offers to the user;
receiving, at at least one selection time, indications that the user has selected ones of said presented food offers;
storing the at least one selection time in the computer;
receiving, by the computer, a proof of purchase receipt from the user, the receipt representing a date and time of a purchase transaction that included food items, said receipt listing said food items;
matching at least one of said listed food items to a respective at least one of said selected food offers;
confirming that the date and time of the purchase transaction is later than a corresponding selection time of the matched at least one selected offer; and
based on results of the matching and confirming steps, providing a benefit to the user.

20. The method of claim 19, wherein the proof of purchase receipt is an electronic receipt.

21. The method of claim 19, wherein the proof of purchase receipt is an image obtained by scanning a paper receipt provided to the user in connection with the purchase transaction.

22. The method of claim 21, further comprising:
parsing the image to determine the listed food items and the date and time of the purchase transaction.

23. The method of claim 19, further comprising;
prior to the step of receiving the request for offers, storing the food offers in the computer such that the stored food offers are associated with a unique identifier that identifies the user.

24. The method of claim 23, wherein said request for offers includes said unique identifier.
